(19) United States
(12) Patent Application Publication
(10) Pub. No.: US 2004/0107131 A1
(43) Pub. Date: Jun. 3, 2004

(54) Value innovation management system and methods

(76) Inventors: Shawn R. Wilkerson, Morganton, GA (US); Eric G. Berggren, Chicago, IL (US); Stefanie A. Zucker, Atlanta, GA (US)

Correspondence Address: Jack D. Todd, Esq., Morris, Manning & Martin, LLP, 3343 Peachtree Road, N.E., Atlanta, GA, 30326-1044, US

(21) Appl. No.: 10/715,303

(22) Filed: Nov. 17, 2003

Related U.S. Application Data
(60) Provisional application No. 60/426,997, filed on Nov. 15, 2002.

(51) Int. Cl. G06F 17/60

(52) U.S. Cl. 705/10

(57) ABSTRACT

A multi-user, network-based computer program and database provides a faster, less-time consuming, iterative process for (a) determining what customers of a client value both currently and in the future, (b) grouping those customers into common market segments, (c) articulating winning value propositions (including required customer experiences and the price to charge) to target customers, and (d) documenting organizational/functional and business partner requirements for delivering the chosen value to the customer (including both actions to create and to communicate the value to customers).

### CROSS REFERENCE TO RELATED APPLICATION

This application claims priority in the United States under 35 U.S.C. § 119(e), and under the Paris Convention worldwide, to the benefit of the filing date of Wilkerson et al. U.S. provisional patent application serial No. 60/426,997, entitled “Value Innovation Management System and Methods,” filed Nov. 15, 2002, which is incorporated herein by reference. This application also incorporates herein by reference the international patent application filed concurrently herewith on Nov. 17, 2003, in the U.S. Patent & Trademark Office and bearing serial no. PCT/US ______, entitled “Value Innovation Management System and Methods.”

### FIELD OF THE PRESENT INVENTION

The present invention relates generally to computer network-based data management systems and, more specifically, to computer network-based data integration and management systems and methods for analyzing individual customer organizations of a business organization, developing a comprehensive set of business requirements to win their business, and grouping those individual customer organizations into market segments to enable more efficient targeting and resource allocation.

### BACKGROUND OF THE PRESENT INVENTION

All businesses, at some level, strive to understand their customers better than their competitors. Superior customer knowledge enables a business to focus its scarce resources on actions that create the highest probability of profitably winning the business of their customers. Thus, businesses that are able consistently to create unique, forward-looking, accurate assessments of what their customers value and translate that value into organizational requirements grow faster and more profitably. While this ability to innovate is widely pursued, most organizations are not satisfied with their current abilities. For example, in 1999, Arthur D. Little found that 85% of the 700 companies surveyed were “dissatisfied with their ability to manage innovation.” To date, successfully innovating and managing customer value has been limited by the many different obstacles.

One obstacle lies in the incorrect assumption that customers actually know and can articulate what they want and what is important to them. For example, many organizations ask their customers what is important to them, and they listen to the response. The problem is that customers typically have not given much thought to the question and do not, in fact, have a distinct idea of their requirements or how to articulate them clearly. When customers are asked what is important to them, they must make an abstraction about their behavior. The reality is that these abstractions are notoriously incorrect. People, when thinking about how they will behave, tend to sound more thorough, objective, and intelligent than their true behavior. Another problem is that customers do not understand the business and technology of their vendors or service providers, so they really do not know what is possible. Furthermore, customers like to make suggestions that they believe will be implemented; therefore, they tend to focus on incremental opportunities instead of breakthrough leaps in value.

A number of Internet-based market research services exist, such as those found at the following web sites on the Internet: www.quicktake.com, www.guidestarco.com, www.zoomerang.com, www.surveybuilder.com, www.greenfield.com, www.intersurvey.com, and www.knowledgenetworks.com. Each of these services allows a user to create a survey for their customer to answer online. Those answers are, to a greater or lesser degree, tabulated automatically for the user to view. These technologies rely exclusively on customer perception and do not have a means to enable the user to incorporate or assimilate their own observations about the customer into the data for analysis.

Many companies are increasingly relying on a relatively new area of network-based, customer database management, called Customer Relationship Management (CRM). Most of the large systems-integration firms, such as Accenture, Computer Sciences Corporation, EDS, E.piphany, SAP, Siebel Systems, and PeopleSoft, have off-the-shelf CRM systems that are customizable and installed for their clients. In these systems, past interactions between a vendor and its customers are captured. Information is retrieved and used during each subsequent interaction with a respective customer to improve the experience during the subsequent interaction. These systems are able to aggregate customer behavioral data to help vendors analyze customer satisfaction levels and customer usage of specific products and/or services, for example. Even though these systems track actual customer behavior, they lack the ability to understand the customers' experiences with the vendor's competition. Understanding the customers' experience with the vendor's competition enables the vendor to quantify the value of their own offering relative to their competitor's offering and, thus, establish optimal pricing strategies and improve effectiveness of marketing communications. CRM tools, by definition, require some previous customer interaction to capture any behavioral data. Furthermore, CRM systems are not designed to capture a customers' objectives, motivations, and other psychological factors that cause their behaviors. For most companies, understanding and acting on their non-customer dissatisfaction presents a much greater growth opportunity than focusing exclusively on current customers.

A growing body of theory and research highlights the need to do on-site, more anthropological visits with customers in order to get ahead of one's competition, but the adoption of this approach to understanding customers has been slowed by several obstacles that, to date, have not been overcome. First, the time required to gather and analyze customer data acquired on-site has been too high because it requires in-person visits with customers followed by days of post-visit analyses. As a result, organizations typically eliminate or skip steps in the data acquisition and analysis process that would help them identify customer insights that could lead to competitive advantages. Second, once at the customer site, vendors often rely exclusively on their customer's perception instead of incorporating their own observations. Third, even if vendors are including their own observations, such observations are made by multiple individuals using their own assessments—making accurate comparison of the resulting customer data difficult, if not impossible. Finally, in-depth, on-site customer visits typically generate significantly more data per customer than traditional market research techniques. Because of this data overload, it is difficult to synthesize such data consistently and it is easy to overlook the most important implications that could be drawn from such data.

Ultimately, all organizations need to group customers into segments in order to evaluate their attractiveness and potential for further investment. These segments are usually derived either statistically using techniques such as cluster analysis or more arbitrarily through demographic or other descriptive classifications. An obstacle with currently available systems and techniques is the fact that statistical techniques, such as cluster analysis, require large sample sizes of customers—typically 200 or more.

Further, pre-defined demographic segmentation ignores the value required by customers in identifying the customer groups. There has not been a consistently reliable method for generating customer value (or customer needs) based segmentation schemes from predominantly qualitative customer data.

Yet another obstacle is the fact that existing Internet survey and CRM tools do not have the ability to translate customer requirements or needs into a definable implementation (i.e., a functional/organizational requirements) for the vendor and its business partners. To date, most organizations have relied on a variety of matrix-analysis-based theories, having buzz-words such as Quality Function Deployment (QFD) or Total Quality Management (TQM); however, current systems have not been able to convert such theories into workable network-based, multi-user system for use in customer value innovation and management.

Another disadvantage of existing systems is that they rely upon static (single point-in-time) analysis of customer value. Organizations conduct periodic studies to attempt to identify what their customers value at that point in time, develop a strategy to address the same, and then execute that strategy for some period of time. At some point in time, the organization determines or realizes that its strategy is out-of-date, so a new study is commissioned and the process starts all over. In between studies, new customer data is difficult to assimilate into the strategy; thus, evolving customer needs are often ignored until the new study is commissioned and new strategy is completed.

Another obstacle with known systems is the fact that multiple divisions within a single organization may have common customers, distributors, or functions (such as R&D). However, most customer analysis and business planning is done independently by each division. Other divisions have limited ability to identify useful information in other areas of the company and, therefore, end up recreating the data and analysis at additional and unnecessary cost to the company.

Another obstacle is the fact that most organizational/functional requirements developed to meet customer needs and requirements are developed by an individual or a small sub-set of individuals within an organization. It is extremely difficult for one person or a small group of people to identify all of the required actions, let alone the most efficient alternatives, that the organization should implement.

Once customer needs and the organizational requirements to meet such needs have been identified, the business organization must act on it. Employees are more likely to change their behavior if they feel that they had some input into the decision. Unfortunately, the current approach to innovation usually has a small team of individuals and/or consultants doing the innovation, who then present their results to the organization as a whole. Getting non-involved individuals within the organization to implement such innovations and requirements is typically quite difficult.

U.S. Pat. No. 6,115,691 issued to Ulwick and entitled “Computer based Process for Strategy Evaluation and Optimization based on Customer Desired Outcomes and Predictive Metrics” discloses a computer system for strategy evaluation and optimization yielding a strategic option, which best satisfies the customer desired outcomes. This invention, however, does not address several of the obstacles noted above. For example, the customer outcomes are required to be customer-rated; thus, relying exclusively on customer perception of those outcomes. Furthermore, customer-identified ratings are typically based on importance of the need to the customer and the customer's satisfaction with their current vendor. But such ratings ignore performance of the user's organization relative to other competition. In addition, the process described in Ulwick requires that customer data be previously captured—so it does not reduce data collection time in any way. Furthermore, Ulwick teaches that customer data must be captured by “experts” instead of the potential user of the system. Customer outcomes are loaded by the user according to customer segment; thus, the process explained in Ulwick requires that segmentation already be completed prior to the start of the use of the Ulwick invention. This system does not help the user define the segments. The Ulwick invention requires that the customer outcomes be static; therefore, the method assumes that customers' value requirements will remain static over time, which is usually not true. Finally, Ulwick teaches that its process is run by a single user at a single location. This requirement increases the amount of time required to gather input from others within the organization, limits the ability to leverage resident knowledge within the organization, and limits buy-in by others within the organization for the resulting analysis.

U.S. Pat. No. 5,991,735 issued to Gerace and entitled “Computer Program Apparatus for Determining Behavioral Profile of a Computer User” describes a method for determining the profile of a computer user and providing (i) a data assembly for displaying customized information to a computer user, and (ii) a tracking and profiling member for recording user activity with response to information displayed through the data assembly. Over time, the tracking and profiling member holds a history and/or pattern of user activity that is, in turn, interpreted as a user's habits and preferences. To that end, a psychographic profile is inferred from the recorded activities. Its goal is limited to increasing advertising effectiveness and increasing immediate sales. The invention merely records actual computer behavior, it does not allow for in-person observation or questioning of the customer to identify potential improvements and the economic and/or psychological value of those improvements. By limiting the data collection to computer behavior, the invention does not enable the user to do any on-site, anthropological customer visits. In addition, the Gerace invention stops before any functional or business partner requirements are defined. Finally, a single user is permitted at any one time limiting the invention's ability to utilize past customer analyses, leverage technical knowledge resident in the non-user employees, and create buy-in to the results among the rest of the organization.

U.S. Pat. No. 5,721,831 issued to Waits and entitled “Method and Apparatus for Recording Results of Marketing Activity in a Database of a Bank, and for Searching the Recorded Results” discloses a user interface for extracting and manipulating data contained in a bank's customer database. Waits teaches a system that allows a market analyst of a bank to divide a customer database into segments and to examine the response of selected segments to marketing strategies. Its stated goal is to track segment responsiveness to specific marketing tactics. The teaching of Waits is very similar to the teaching of Gerace—the main differences being that Waits focuses exclusively on individual bank customers and their banking behavior while Gerace focuses on individual computer users and their computing behavior.

U.S. Pat. No. 5,041,972 issued to Frost and entitled “Methods of Measuring and Evaluating the Consumer Response for the Development of Consumer Products” discloses a method for evaluating consumer response and relates to methods for performing market research. Such market research involves measuring and evaluating the responses of consumers (or of the relevant audience) to consumer products that are to be marketed or presented to the audience, the members of which are in a position to choose between the items. The object of such methods is to determine how members of the audience will react to the introduction of specific new products to the market or to changes in the characteristics of an existing product. This process requires that a product concept already be created and static. It also relies exclusively on customer-stated expected behavior and does not allow for observation of actual past behavior. Further, it does not address segmentation or functional and business partner requirements.

U.S. Pat. No. 5,416,694 issued to Parrish et. al. teaches a computer-based data integration and management process for work force planning and occupational free adjustment. Parrish teaches a system and method using a number of databases that are either created internally or are imported from existing databases. These databases are manipulated by the invention or skill matching analysis based on a rigorous behavioral skill analysis of target occupations, using one or more predetermined analysis metrics and an examination of individual skills using metrics with similar behavioral attributes. This invention does not analyze individual customers or segment customers, and does not define organizational/functional requirements.

None of the foregoing references provide a readily adaptable computer network-based data integration and management process for identifying new sources of value to current and/or potential customers, segmenting those customers, and defining organizational/functional requirements for the chosen value. In addition, known methods and systems do not address or overcome the obstacles and disadvantages noted above.

For these and many other reasons, there is a general need for a system and method for providing a multi-user, network-based computer program and database to provide a faster, less time consuming, iterative, simultaneous multi-user process for (a) determining what customers of a business value both currently and in the future, (b) grouping those customers into common market segments using both qualitative and quantitative data, (c) articulating winning value propositions (including required customer experiences and price to charge) to target customers, and (d) documenting functional and business partner requirements for delivering the chosen value to the customer.

There is also a need for a network-based, computerized method for enabling a client to identify a target customer and develop value delivery strategies for obtaining business from the target customer, comprises the steps of defining a value delivery network of the client, the value delivery network including the target customer, defining a team from the client to visit with the target customer, during the visit with the target customer, documenting current events of relevance to the target customer and perfect events idealized by the target customer, developing preferred events based on the current events and perfect events documented during the visit, identifying improved experiences available to the target customer based on the preferred events, developing a value proposition for the target customer based on the improved experiences identified, and developing a value delivery strategy for implementing the value proposition.

There is also a need for a network-based, computerized method for enabling a client to identify customers and develop value delivery strategies for obtaining profitable business from the customers, comprises the steps of defining a respective team from the client to visit with each of a plurality of customers, visiting each of the plurality of customers, during each respective visit, documenting current events of relevance to each respective customer and perfect events idealized by each respective customer, developing preferred events for each respective customer based on the current events and perfect events documented during each respective visit, identifying improved experiences available to each respective customer based on the preferred events, developing a respective value proposition for each respective customer based on the improved experiences identified, developing a respective value delivery strategy for implementing each respective value proposition, and grouping the plurality of customers into common segments based on similarity of respective value propositions or value delivery strategies.

The present invention meets one or more of the above-referenced needs as described herein in greater detail.

### SUMMARY OF THE PRESENT INVENTION

The present invention relates generally to computer network-based data management systems and, more specifically, to computer network-based data integration and management systems and methods for analyzing individual customer organizations of a business organization, developing a comprehensive set of business requirements to win their business, and grouping those individual customer organizations into market segments to enable more efficient targeting and resource allocation. Briefly described, aspects of the present invention include the following.

In a first aspect of the present invention, a network-based, computerized method for enabling a user, otherwise known as the client to identify a target customer and develop value delivery strategies for obtaining business from the target customer, comprises the steps of defining a value delivery network of the client, the value delivery network including the target customer, defining a team from the client to visit with the target customer, during the visit with the target customer, documenting current events of relevance to the target customer and perfect events idealized by the target customer, developing preferred events based on the current events and perfect events documented during the visit, identifying improved experiences available to the target customer based on the preferred events, developing a value proposition for the target customer based on the improved experiences identified, and developing a value delivery strategy for implementing the value proposition.

In a feature of the first aspect, the client value delivery network is defined, preferably comprising the steps of identifying value delivery partners and customers of the client

In another feature of the first aspect, the step of identifying the target customer comprises identifying a plurality of customers and potential customers of the client.

In yet other features, the method preferably includes the step of defining a schedule for conducting customer visits, and the step of providing the team with surveys for completion prior to the visit to the target customer.

In a feature, the method further comprises defining a project work plan for the target customer. Preferably, interaction between the team and the target customer is defined by a work plan of a project and wherein each member of the team is permitted to modify the work plan on an on-going basis. Further, members of the team are preferably able to modify the work plan remotely and independently from other members of the team.

In another feature of the first aspect of the invention, the step of documenting events comprises documenting perceptions of the target customer and observations made by the team.

In another feature, the step of documenting current events further comprises documenting previous experiences between the client and the target customer, and documenting previous experiences between the target customer and competitors of the client.

Preferably, the step of documenting events includes identifying an historical event that happened to the target customer, documenting specific challenges faced by the target customer as a result of the event, and identifying the target customer's vision of a perfect event.

In another feature, the method preferably includes the step of identifying improvement opportunities for validation by the customer. Also preferred is the method wherein, a priority is assigned to each of the opportunities, wherein the priority is preferably defined as being high, medium, or low.

In another feature, the method includes the step of identifying improved experiences for the target client based on the documented current events, perfect events and improvement opportunities. Yet further, the step of identifying improved experiences preferably comprises identifying steps that the client can take to convert a respective historical event into a respective preferred event and wherein the respective preferred event is further defined as an improved experience.

Preferably, each improved experience is assigned a worth and consequences of the improved experience are identified. Also preferred is the method wherein, for each improved experience, a best alternative most likely to provide the improved experience to the target customer is identified, the best alternative being a competitor of the client.

In another feature of the first aspect, the step of developing the value proposition includes assigning a relative performance value compared to the best alternative, and a relative importance value to each improved experience identified.

In yet another feature, the value proposition includes a time horizon, required target customer experiences, and a price that will be charged by the client for each respective improved experience. Further, members of the team are preferably able to modify the value proposition remotely and independently from other members of the team.

In yet a further feature of the first aspect of the invention, the step of developing the value delivery strategy comprises defining how each improved experience will be created for the target customer and defining how each improved experience will be communicated to the target customer and within the client. Preferably, the step of defining how each improved experience will be created comprises identifying required actions by the target customer, the client and value delivery partners. Yet further, it is preferred that the step of defining how each improved experience will be communicated comprises identifying content and mode of delivery of the communication with the target customer and the client.

In another feature of the first aspect, the method further comprises identifying required actions of the client, partner organizations, and the target customer to experience the value proposition over a chosen time horizon. Preferably, the required actions are assigned to specific functional areas within the client or to at least one of the partner organizations and wherein the assigned required actions are stored in a database of the network. Further, and also preferable, the required actions are assigned estimates of cost and time until implementation and wherein the required actions are stored in a database of the network.

Further, members of the team, as well as other members of the client organization are preferably able to modify the value delivery strategy remotely and independently from other members of the team.

In yet another feature of the first aspect of the invention, the step of defining next steps further comprises assigning a member of the team to each step.

In a different feature, wherein the above steps are repeated for a plurality of target customers and wherein segments of target customers are identified based on data collected and maintained for the plurality of target customers. Preferably, the value propositions and value delivery strategies are developed for segments of target customers.

In a second aspect of the invention, a network-based, computerized method for enabling a client to identify customers and develop value delivery strategies for obtaining profitable business from the customers, comprises the steps of defining a respective team from the client to visit with each of a plurality of customers, visiting each of the plurality of customers, during each respective visit, documenting current events of relevance to each respective customer and perfect events idealized by each respective customer, developing preferred events for each respective customer based on the current events and perfect events documented during each respective visit, identifying improved experiences available to each respective customer based on the preferred events, developing a respective value proposition for each respective customer based on the improved experiences identified, developing a respective value delivery strategy for implementing each respective value proposition, and grouping the plurality of customers into common segments based on similarity of respective value propositions or value delivery strategies.

In a feature of the second aspect of the invention, the method further comprises the step of creating segment and line of business level requirements for functional areas within the client and for business partner organizations that help serve the customers. Preferably, a single user or multiple users of the client individually or simultaneously are able to query a database of the network to create subsets of data that relate only to one or more of the following common elements: client, client line of business, client project, client functional area, partner organization, customer, customer segment, customer experience, and price charged to the customer.

In another feature of the second aspect, value propositions and value delivery strategies are developed for at least one of the common segments. Further, members of the team, as well as other members of the client organization are preferably able to modify the value propositions and value delivery strategies remotely and independently from other members of the team.

The present invention also encompasses computer-readable medium having computer-executable instructions for performing methods of the present invention, and computer networks and other systems that implement the methods of the present invention.

The above features as well as additional features and aspects of the present invention are disclosed herein and will become apparent from the following description of preferred embodiments of the present invention.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 is a graphical illustration of a value delivery network (VDN) as used with the present invention;

FIG. 2 is a graphical illustration of a value delivery strategy (VDS);

FIG. 3 is an overview block diagram of an aspect of the present invention;

FIG. 4 is a flow chart illustrating steps associated with the block diagram of FIG. 3;

FIG. 5 is a flow chart illustrating further steps associated with the block diagram of FIG. 3;

FIGS. 6a and 6b are flow charts illustrating further steps associated with the block diagram of FIG. 3;

FIGS. 7a and 7b are flow charts illustrating further steps associated with the block diagram of FIG. 3;

FIG. 8 is a flow chart illustrating further steps associated with the block diagram of FIG. 3;

FIG. 9 is a flow chart illustrating further steps associated with the block diagram of FIG. 3;

FIG. 10 is a flow chart illustrating further steps associated with the block diagram of FIG. 3;

FIG. 11 is a flow chart illustrating further steps associated with the block diagram of FIG. 3;

FIGS. 12-14 are screen shots corresponding to Step 400 of FIG. 4 and Step 512 of FIG. 5;

FIGS. 15-16 are screen shots corresponding to Step 402 of FIG. 4;

FIG. 17 is a screen shot corresponding to Step 414 of FIG. 4;

FIG. 18 is a screen shot corresponding to Step 416 of FIG. 4;

FIG. 19 is a screen shot corresponding to Step 418 of FIG. 4;

FIG. 20 is a screen shot corresponding to Step 420 of FIG. 4;

FIG. 21 is a screen shot corresponding to Step 422 of FIG. 4;

FIGS. 22-24 are screen shots corresponding to Step 514 of FIG. 5;

FIG. 25 is a screen shot corresponding to Step 516 of FIG. 5;

FIG. 26 is a screen shot corresponding to Step 518 of FIG. 5;

FIG. 27 is a screen shot corresponding to Step 520 of FIG. 5;

FIGS. 28-30 are screen shots corresponding to Step 524 of FIG. 5;

FIGS. 31-32 are screen shots corresponding to FIG. 5 generally;

FIG. 33 is a screen shot corresponding to Step 600 of FIG. 6a;

FIG. 34 is a screen shot corresponding to Step 604 of FIG. 6a;

FIGS. 35,36, and 38 are screen shots corresponding to Step 606 of FIG. 6a;

FIG. 37 is a screen shot corresponding to Step 606 of FIG. 6a and Step 612 of FIG. 6b;

FIGS. 39-40 are screen shots corresponding to Step 612 of FIG. 6b;

FIG. 41 is a screen shot corresponding to Steps 614 and 616 of FIG. 6b;

FIG. 42 is a screen shot corresponding to Steps 618 and 620 of FIG. 6b;

FIG. 43 is a screen shot corresponding to Steps 622 and 624 of FIG. 6b;

FIG. 44 is a screen shot corresponding to Step 626 of FIG. 6b;

FIGS. 45-46 are screen shots corresponding to Step 628 of FIG. 6b;

FIG. 47 is a screen shot corresponding to Step 700 of FIG. 7a;

FIG. 48 is a screen shot corresponding to Steps 702, 704 and 706 of FIG. 7a;

FIG. 49 is a screen shot corresponding to Steps 708 and 710 of FIG. 7a;

FIG. 50 is a screen shot corresponding to Steps 712 and 714 of FIG. 7a;

FIG. 51 is a screen shot corresponding to Step 716 of FIG. 7a;

FIG. 52 is a screen shot corresponding to Steps 718, 720, 722 and 724 of FIG. 7b;

FIG. 53 is a screen shot corresponding to Step 726 of FIG. 7b;

FIG. 54 is a screen shot corresponding to Steps 728, 730 and 732 of FIG. 7b;

FIG. 55 is a screen shot corresponding to Steps 734 and 744 of FIG. 7b;

FIG. 56 is a screen shot corresponding to Step 736 of FIG. 7b;

FIG. 57 is a screen shot corresponding to Steps 738, 740 and 744 of FIG. 7b;

FIG. 58 is a screen shot corresponding to Steps 742 and 744 of FIG. 7b;

FIGS. 59-60 are screen shots corresponding to Step 746 of FIG. 7b;

FIG. 61 is a screen shot corresponding to Step 800 of FIG. 8;

FIG. 62 is a screen shot corresponding to Step 802 of FIG. 8;

FIG. 63 is a screen shot corresponding to Step 804 of FIG. 8;

FIG. 64 is a screen shot corresponding to Step 900 of FIG. 9;

FIG. 65 is a screen shot corresponding to Step 902 of FIG. 9;

FIGS. 66-68 are screen shots corresponding to Steps 904 and 906 of FIG. 9;

FIGS. 69-70 are screen shots corresponding to Steps 904 and 908 of FIG. 9;

FIG. 71 is a screen shot corresponding to Step 912 of FIG. 9;

FIG. 72 is a screen shot corresponding to Step 914 of FIG. 9;

FIG. 73 is a screen shot corresponding to Steps 1000, 1002, 1004, 1006 and 1008 of FIG. 10;

FIG. 74 is a screen shot corresponding to Step 1010 of FIG. 10;

FIG. 75 is a screen shot corresponding to Steps 1100, 1102, 1104, 1106 and 1108 of FIG. 11; and

FIG. 76 is a screen shot corresponding to Step 1110 of FIG. 11.

### DETAILED DESCRIPTION OF PREFERRED EMBODIMENTS

Illustrative embodiments of the invention are described below as they might be employed in a multi-user, network-based computer program and database to provide a faster, less time consuming, iterative process for determining customer value and translating that value into organizational/functional business requirements. In the interest of conciseness, not all features of an actual implementation are described in this specification. It will, of course, be appreciated that in the development of any actual embodiment, numerous implementation-specific decisions must be made to achieve the developer's specific goals, such as compliance with system-related and business-related constraints. Moreover, it will be appreciated that even if such development effort might be complex and time-consuming, it would nevertheless be a routine undertaking for one of ordinary skill having the benefit of this disclosure.

What is needed in the industry, and is not currently available using traditional marketing and functional planning methodologies and their technological counterparts, is a means to gather, analyze, and evaluate “real-life” customer experience data to support strategic decision making in a manner that is both timely and rigorous. The present invention provides methods and systems for generating customer value requirements, customer segmentation, functional requirements, and channel partner requirements reports based on an aggregation of user supplied, customer and competitor data. The invention allows users to more efficiently and effectively synthesize qualitative customer data than is currently possible with known systems and methods. In other words, users of the present invention are able to make use of qualitative customer data in important strategic decision-making on a consistently accurate basis.

The network capabilities of the present invention enable organizations simultaneously to utilize the knowledge of multiple users throughout their organization without the limitations of physical proximity or a common meeting time. Thus, the invention enables organizations to incorporate more information from more diverse perspectives than have previously been possible using existing market research tools and methodologies. Greater participation creates a feeling of personal ownership of the results which dramatically increases the probability that the organization will implement the recommendations.

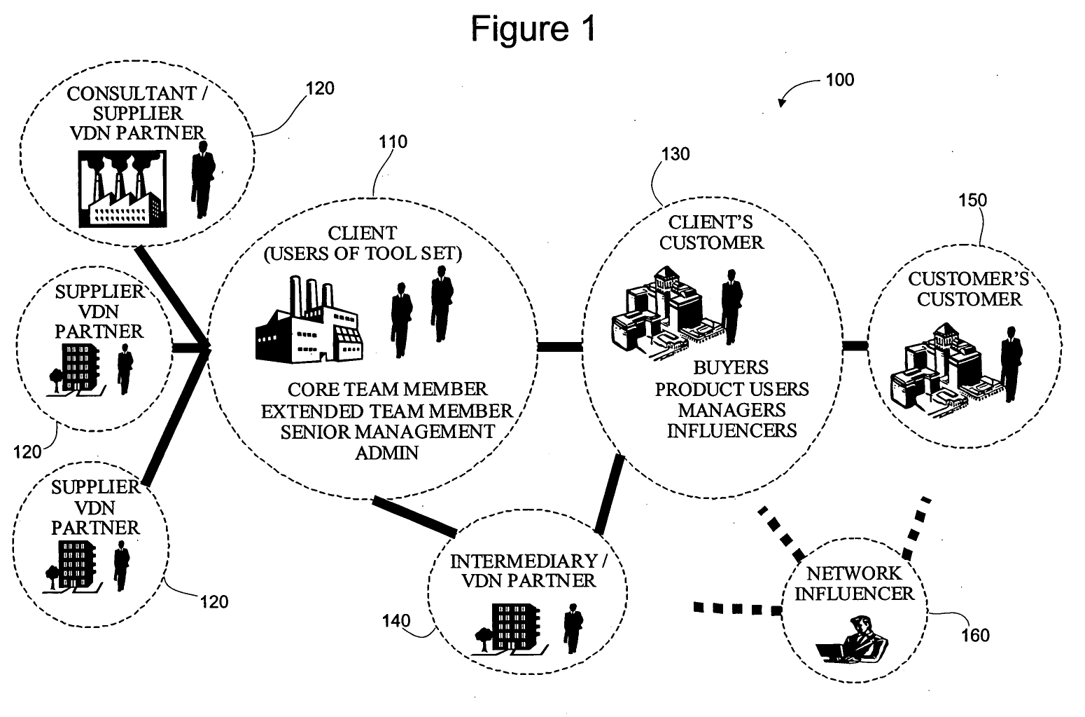

As shown in FIG. 1, the system and processes of the present invention are useful in a value delivery network 100 (VDN) of an organization or client 110. The client 110 includes users of the tool sets made available by the present invention and also includes core team members, extended team members, senior management, and administration. The value delivery network 100 defines or at least identifies the primary entities in the marketplace of the client 110. A VDN 100 may be defined in association with a single target customer or with a plurality of target customers of the client 110 in mind. For example, the client 110 has a number of VDN partners 120, such as suppliers, consultants, and other service providers that enable the client to generate and deliver its own goods and services to its customers 130. The client's customer 130 has its own buyers, product users, managers, and influences that affect the relationship between the client 110 and the customer 130. In some situations, there may be an intermediary VDN partner 140 positioned in between or along side both the client 110 and the client's customer 130. In some cases, it is also necessary for the client 110 to know about the customers 150 of the client's own customer 130. Yet further, there are times when it is necessary for the client to be aware of any relevant network influencers 160.

According to the invention, the user engages in a multi-step process, whereby, for example, a project team is created, team members are surveyed to establish baseline project information, select customers (current and potential) are targeted for visits, customer data is gathered and entered into a database and potential solutions to improve existing customer problems along with their delivery requirements are hypothesized, and entered into the database. The user then extracts 3 different market segmentation reports from the database and queries the database for individual departmental functional requirements and channel partner delivery requirements. The unique design of the invention, a step-by-step cumulative data-gathering process, compels the user to answer all questions before proceeding to the next “step” thereby ensuring that rigor is not compromised even when a timely answer is needed.

More specifically, to implement the systems and methods of the present invention, users of the client access the system on any networked-connected computer with a previously defined password in conventional manner. A primary user first defines a project or market to be analyzed. Part of defining a project includes identifying all participants (i.e., other users) who will be involved in the project or market analysis. Based on the project definition, the system generates a baseline work plan for completing the project or market analysis. The system is configured to enable single or multiple users to have access to and rights to modify tasks, their timing, assignment of responsibility, and their status throughout the process. Preferably, such access is independent of physical proximity and common meeting times. Key events associated with the project or market analysis are automatically highlighted in a common calendar to enable the identification of conflicts by any user.

Preferably, before any direct discussions or meetings with customers occur, multiple users associated with the project are surveyed about their own beliefs on a number of subjects relevant to the project. For example, subjects include the “current value” that the client delivers to its customer, the most important trends in the market and their implications, and the conventional wisdom or commonly held (but not necessarily accurate) beliefs about what makes them the client or the trends successful. The invention consolidates this survey information and creates downloadable files of the consolidated results that is readable by many conventional text-based computer applications.

The user(s) then diagrams the value delivery network associated with the client. Part of this diagramming includes defining each entity in the VDN, identifying the size of each entity, identifying the perceived profitability of each entity, and identifying the believed drivers of profit for each entity. Preferably, the VDN includes a number of existing customers and potential customers.

Next, the user(s) define selection criteria to help choose which of the identified customers and potential customers to analyze. The systems and methods of the present invention enable the users to select specific customers who fit each criterion. The present invention facilitates the generation of instructional guides to help facilitate the project. The present invention also guides the user(s) to structure customer visits by identifying specific customer events to analyze. VDNs are preferably created for each customer who will be visited.

A team made up of one or more users then visits a selected customer in-person to capture both customer perception as well as their own observations about that customer's actual behavior. Users are able to capture both vendor-customer experiences and competitor-customer experiences and assess their relative performance.

User(s) are required to define the value requirements or “value proposition” for each individual customer over the course of a specific time period. The value proposition includes a time horizon (e.g., the period of time over which the value proposition will remain superior to the competition), the required improved customer experiences (including the events the customer will experience, the consequences from those events and an estimate of their value to that customer), and a price that will be charged to that individual customer. The present invention enables the user(s) to define how each customer's value will evolve over time rather than forcing a choice of a particular point in time. The system further creates a common scale for assessing the relative importance of each improved customer experience. Multi-user access enables the client to achieve more quickly a shared or common view of each customer and the required actions to win that customer's business.

User(s) also define organizational/functional business requirements to create that value for each customer visited. These requirements include actions that the customer must take, actions that the client's VDN partners must take, and actions that the client must take. Customer actions are further categorized by “when” in the lifecycle of the customer relationship they occur. Similarly, actions by VDN partners are further categorized by “when” in the lifecycle of a business partner relationship they occur. The actions of the client are categorized by functional area and include the development of new products and services and refinements to existing products and services. Organizational/functional requirements also include those actions required to communicate successfully the required value to both customers and the client. Costs are assigned to each action and an estimate of time to implement is captured.

Throughout the analysis, multiple users have the ability to view simultaneously (independent of physical proximity and a common meeting time) the data on any individual customer and contribute ideas and implications, which in turn, reduces the possibility of one user overlooking a critical element of the analysis. It frees up all users from having to make formal presentation(s) to obtain feedback. This critical distinction from the prior art enables more comprehensive and thorough analysis than ever before.

After on-site visits, a report detailing the results of each customer visit is automatically generated by the system. The primary obstacles to conducting these on-site visits are eliminated by enabling simultaneous multi-user input and automating reporting.

The invention structures the data obtained first by customer event and then by customer experience—to make comparisons across customers easier and more accurate. By properly categorizing customer experiences, multiple segmentation alternatives are able to be automatically generated and selected by the user(s). Once a segmentation scheme is selected, segment-specific “value propositions” and “value delivery strategies” are automatically generated by aggregation of the individual customer analyses and strategies. With prior art systems, aggregation of such data is handled manually with a myriad of opportunities to inadvertently omit critical information. Multiple users are then able to view and edit those segment-level “value propositions” and value delivery strategies” independent of physical proximity and a common meeting time.

Further, the systems and methods of the present invention use a matrix analysis to enable segmentation based on customer value with qualitative information and significantly fewer customer observations than the prior art (potentially as few as 3 or 4). The present invention not only collects individual customer data (including the client performance and the performance of the client's competitors) and creates segment level views, but it also automatically generates organizational/functional requirements to win the customers in each segment. Thus, the present invention significantly reduces the time required to conduct and analyze customers in this way.

Further, the systems and methods of the present invention preferably do not permit users to proceed to the next step of the overall process unless and until they have completely executed the previous step. For example, a user cannot analyze a customer event until it has been consistently and thoroughly documented. Therefore, the invention creates more analytical consistency and rigor than the current manual processes carried out by several individuals simultaneously. This consistency in collection of qualitative data is unique to this invention and enables the analytical synthesis of the data during segmentation and functional requirements definition.

Finally, the present invention enables users, at any point in time, to have the ability to add a new customer observation or revise an existing customer observation when that customer has changed. The system automatically creates new comprehensive value proposition statements for each customer segment and revised organizational/functional requirements. Resulting strategies and requirements are not required to be static, and therefore, are far more responsive to changing markets than currently known manual processes.

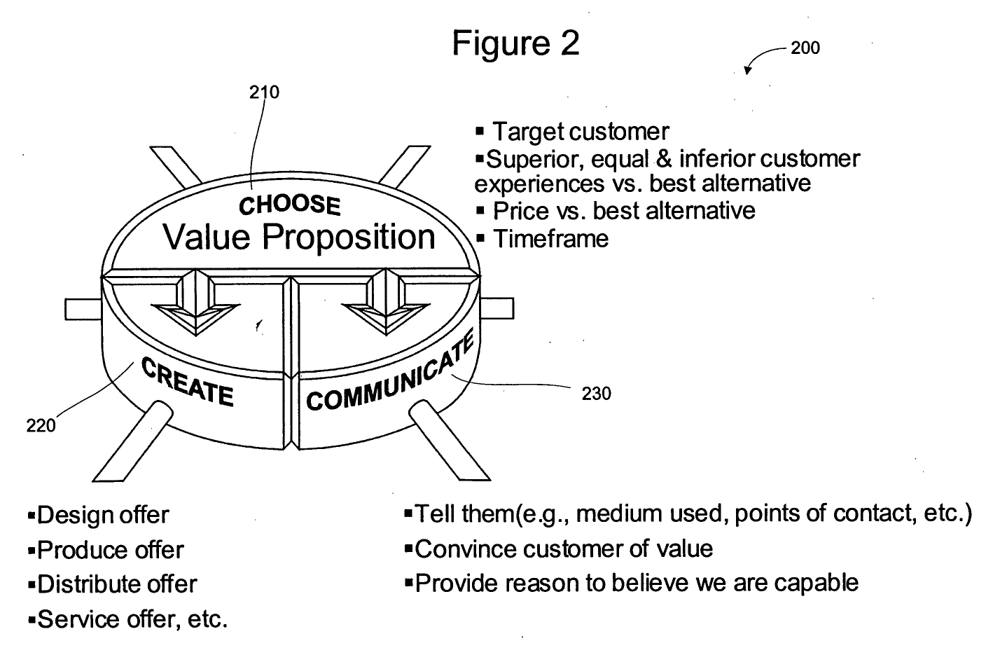

At a high level, FIG. 2 provides a visual illustration 200 of the three key elements for the delivery of a successful, winning strategy: “choosing” the value proposition 210, “creating” the appropriate experiences 220, and “communicating” the proposed experiences to all concerned parties 230.

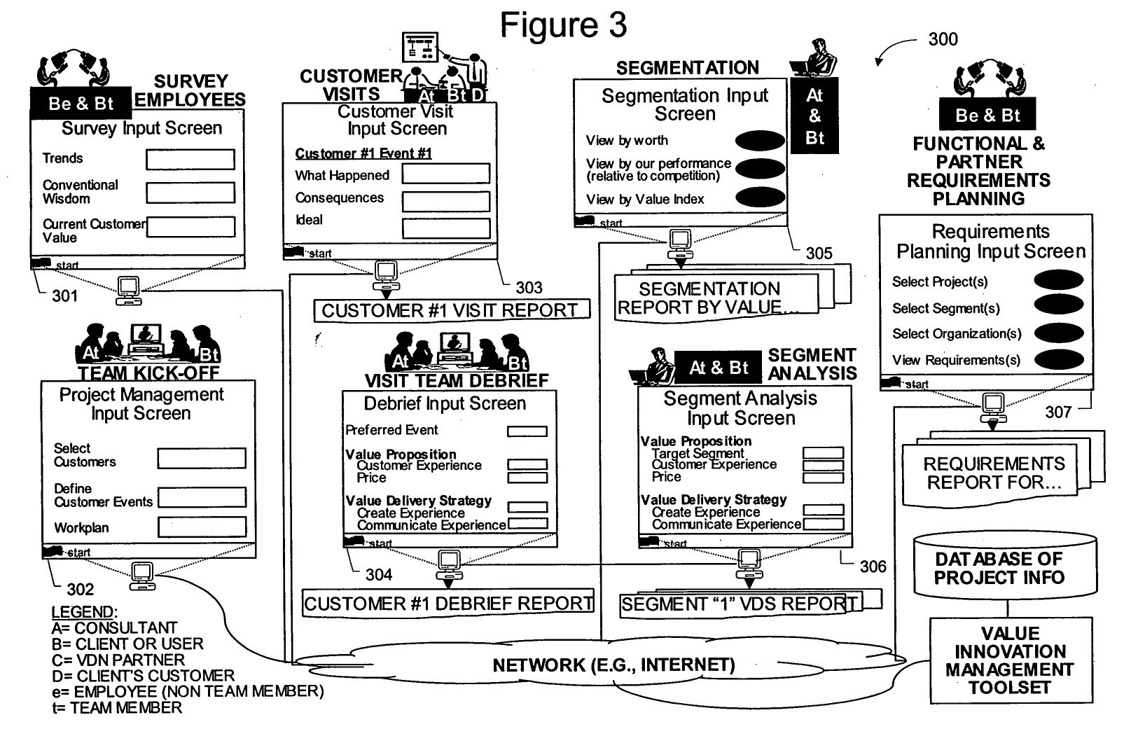

FIG. 3 illustrates at a high level, and in block diagram format, the steps 300 performed by the present invention and which individuals and entities are involved with each. These steps include surveying (step 301) employees, which includes team and non-team members of the client, having a team kick-off session (step 302), during which projects are defined, conducting customer visit(s) (step 303), which leads to the generation of customer visit reports, conducting a visit team debriefing session after a visit (step 304), which leads to the generation of customer debriefing reports, defining segments based on a plurality of visits (step 305), which leads to the generation of segmentation reports by value, conducting segment analysis (step 306), which leads to the generation of segment value delivery service reports, and developing functional and partner requirements plans (steps 307), which leads to the generation of requirements reports for each target customer. Each step of the process includes capture of data and information into the system of the present invention for processing, analysis, aggregation, reporting, and for developing action plans.

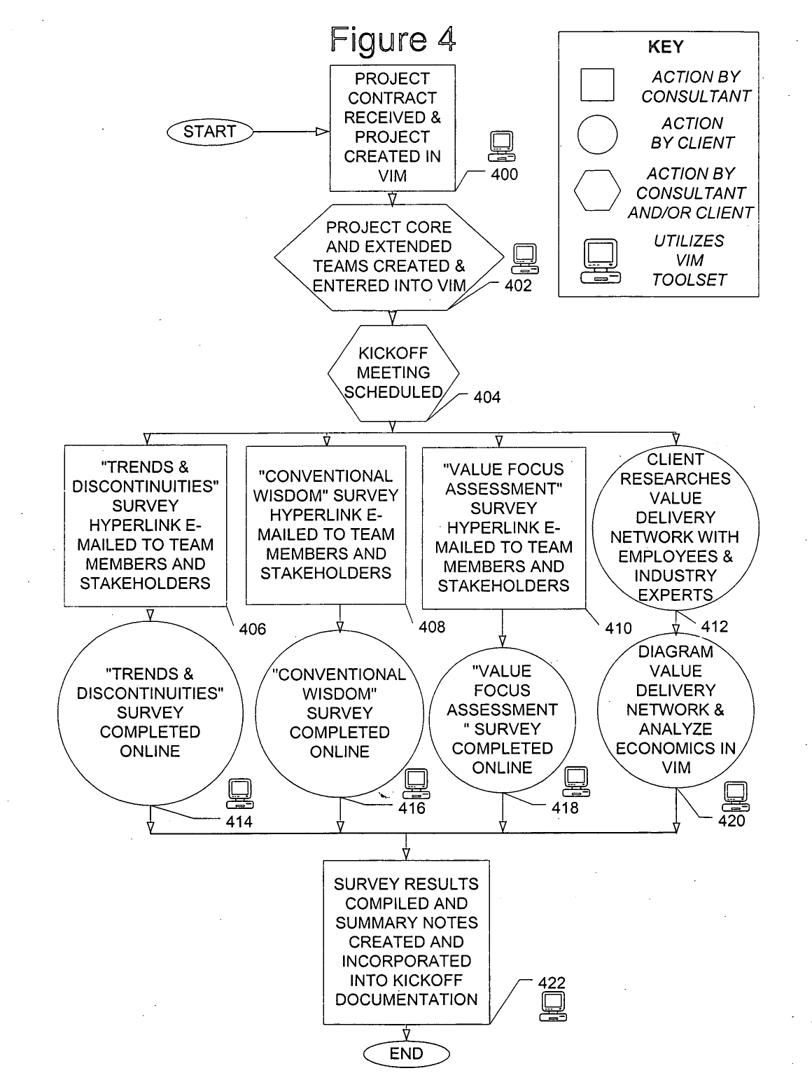

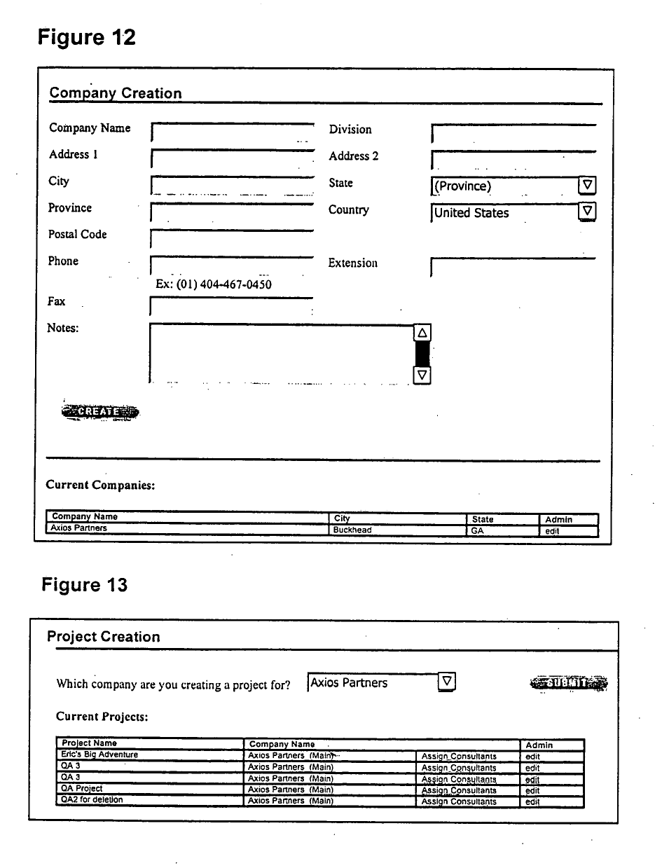

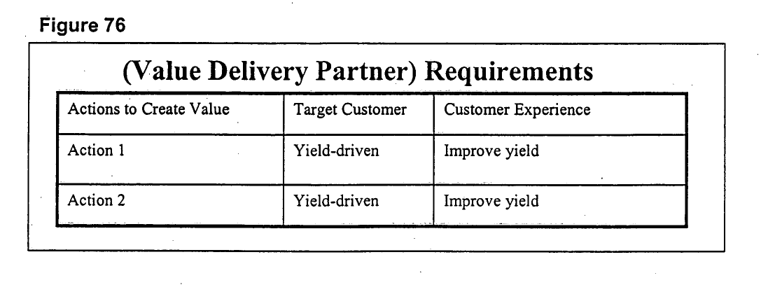

Turning now to FIGS. 4-11, the methods of the present invention highlighted in FIG. 3 are described in greater detail. Exemplary screen shots from FIGS. 12-76, associated with the various steps described in FIGS. 4-11, will be referenced hereinafter as appropriate. Details of such screen shots will only be provided as necessary to help explain particular steps associated with FIGS. 4-11; remaining aspects and features of such screen shots being self-evident from the drawings themselves, as will be appreciated by those skilled in the art. Additionally, it should be understood that such screen shots are shown merely for illustrative purposes, for enablement purposes, and for a more detailed description of the preferred embodiments of the present invention, and not for purposes of limitation. Preferably, the application associated with the present invention is a computer program written in ASP, utilizing a Microsoft web-platform and a SQL database server.

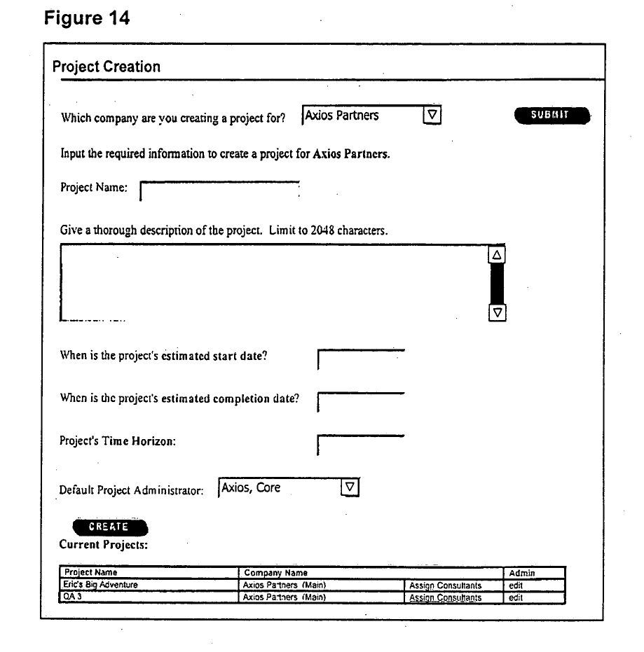

As shown in FIG. 4, the primary user (designated as the site administrator) logs into the application and defines (step 400) a project. It is presumed that the site administrator has already created a company profile for the relevant client. Such company profile may be created using a form, such as that shown in FIG. 12, which is conventional. It should be understood that one company or client may, and likely will, have more than one project defined, as illustrated by the list of projects associated with Axios Partners in FIG. 13. A project creation page is illustrated in FIG. 14, which enables the site administrator to define a project name, description, estimated start date, estimated completion date, and time horizon, among other things. Preferably, access to project information is database-constrained to only those users who belong to the respective client, with specific access to a respective project, and based on user-type. Next, the primary user identifies (step 402) which users of the client are assigned to or associated with the project.

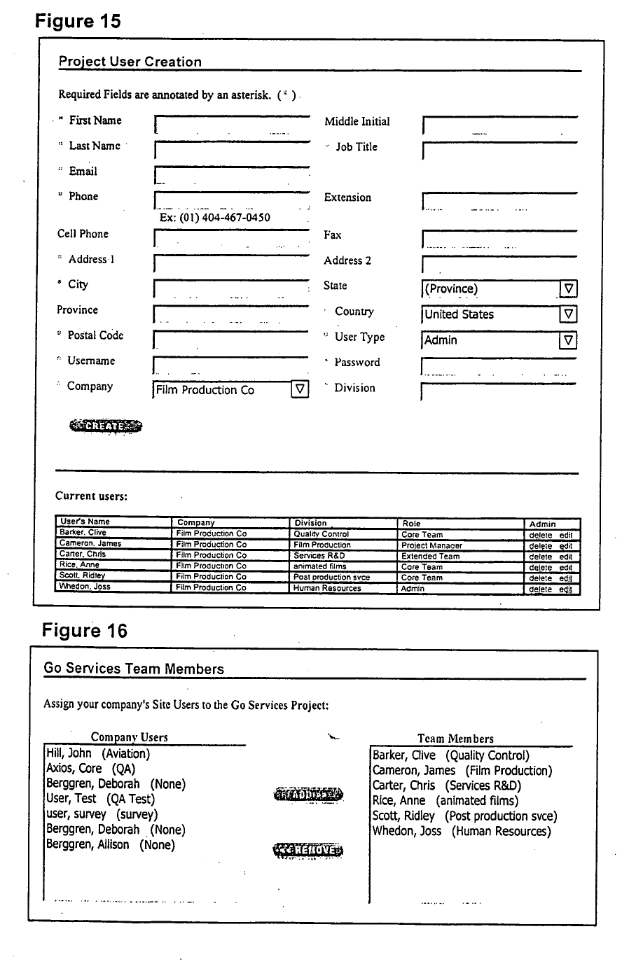

Users of the system are defined and input into the system by the site administrator using a form, such as that shown in FIG. 15. Basic information about each user (name, address, phone number, etc.) is entered here, and is then stored in user account tables. Additionally, “user type” is specified, denoting different levels of access privileges (e.g. project managers have greater access than mere “core team” members). Rights are based on the user type associated with the user at time of creation or upon edit by an authorized user or administrator. Rights are inherited from “user types” that are predefined within a user-associated table and applied to user accounts dependent upon the user's level of responsibility within a project in conventional manner. Screenshots reflecting the information requested to assign a particular user to a particular project is illustrated in FIG. 16.

A kickoff meeting for all team members (users) is then scheduled (step 404). This is done in conventional manner by email or telephone or the like. Preferably, hyperlinks are e-mailed (at steps 406, 408, 410) to key user organization staff and team members providing access to project surveys. Additionally, the team is asked to research (step 412) the various entities (customers, partners, etc.) that comprise their value delivery network (VDN) or marketplace. This compels the user to acknowledge (prior to moving forward with customer contact) other entities and potential partners that may play a key role in delivering value to the customer. It is important to introduce the user, at step 412, to the concept of potential channel partnerships early in the process, because it broadens the users' perspective, enabling them to consider strategic options they might have ordinarily dismissed, as they could not be unilaterally delivered by the user organization itself.

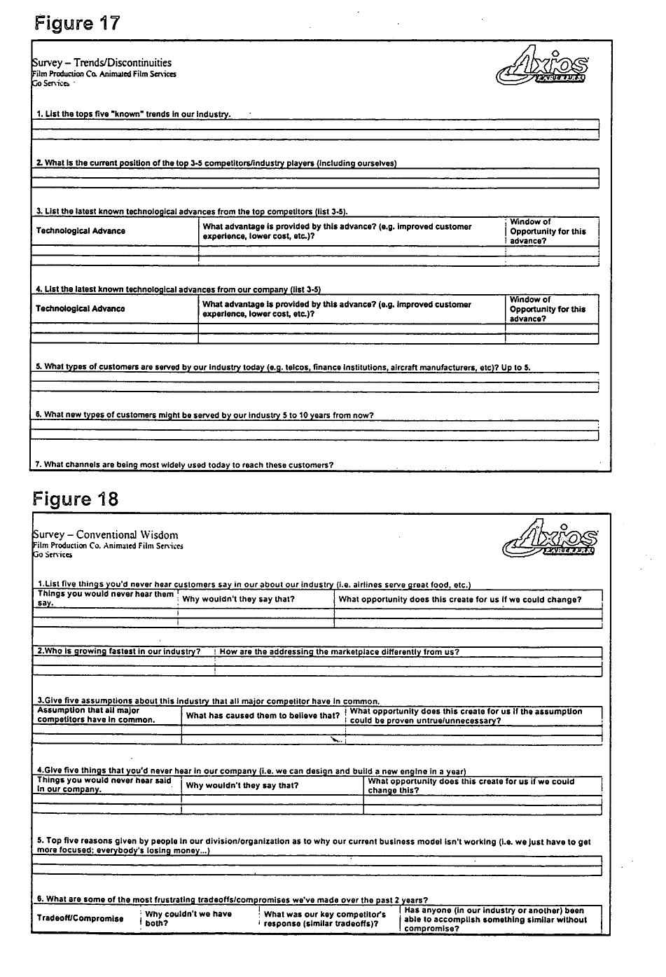

Prior to attending the project kick-off meeting, team members are requested to log in and complete (steps 414, 416, 418) the three surveys (that were emailed to them). These surveys are electronically provided to each user and are maintained by the system. While survey participation is not mandatory, the preferred embodiment of the invention requires users to complete all surveys prior to the project kickoff meeting. These surveys are advantageously structured in such a manner that they do not merely tabulate customer preferences (likes, dislikes, etc.) but rather act as a teaching mechanism—to begin training each user to “think outside the box” prior to the kickoff meeting. The survey tools enable the users to consider a more diverse set of strategic options by identifying those beliefs in the users' organization or environment that limit the users' creativity and exploration of new alternatives. Survey questions are abstract and flexible in that questions are changeable by the system administrator and are maintained in a single table along with their associated answer fields. The web interface queries and displays the survey question ID's with respective answer fields without regard to the data held within answer fields and adjoining answer fields. At any given time, survey questions and associated answer fields can be changed to reflect a specific project. In preferred embodiments, the surveys used and illustrated in FIGS. 17-19 include a combination of questions that have proven to be most effective across a variety of situations.

To access each survey, the user activates the hyperlink from the relevant email and inputs the userID and password provided. Preferably, each user is given a common ID and password so that surveys may be completed in anonymity. Upon completion of the third and last survey, the user is automatically logged off and all data is saved relative to that user (although still anonymous) and project. Preferably, all three surveys are completed within a single session or data is not saved.

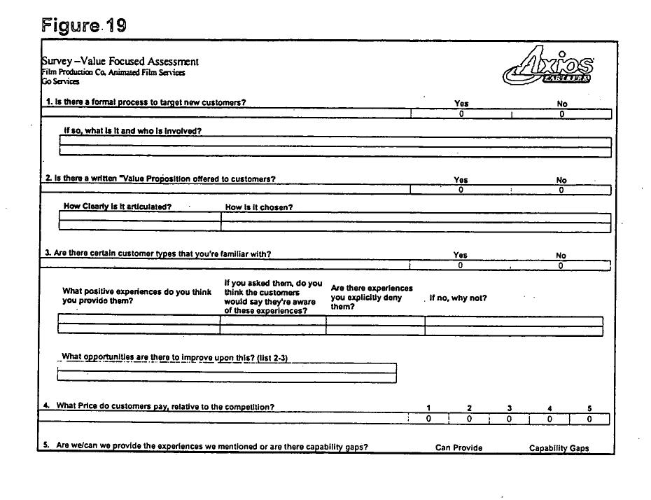

Preferably, the “Value Focused Assessment” survey will appear first, as shown in part in FIG. 17. The user answers all questions, and then selects Next Survey to proceed. The “Conventional Wisdom” survey, as shown in part in FIG. 18, preferably is given next, followed by the “Trends and Discontinuities” survey, as shown in part in FIG. 19. The user answers all questions, and then select Finalize Survey to exit the system.

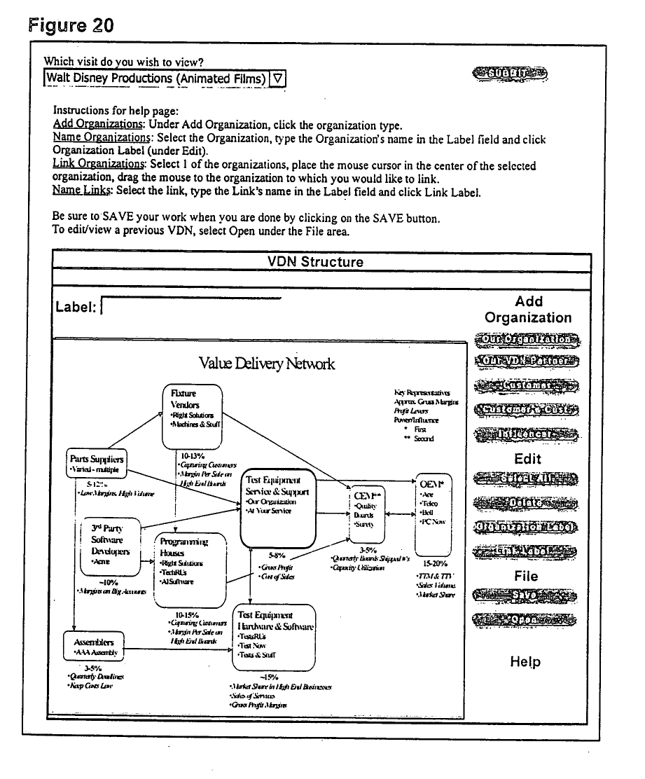

To complete project kickoff preparation, the project's VDN (researched previously at step 412) is created and stored (step 420) within the system. An exemplary VDN is created in graphical format, as shown in FIG. 20. Preferably, the VDN is captured electronically and stored in the system using an Active X application, as is available commercial from companies such as Lassalle Technologies. The Active X application enables information created in the graphical workspace to be stored in database tables using procedures that insert, query, and delete object references that appear through the web interface using flowchart-like symbols in known manner.

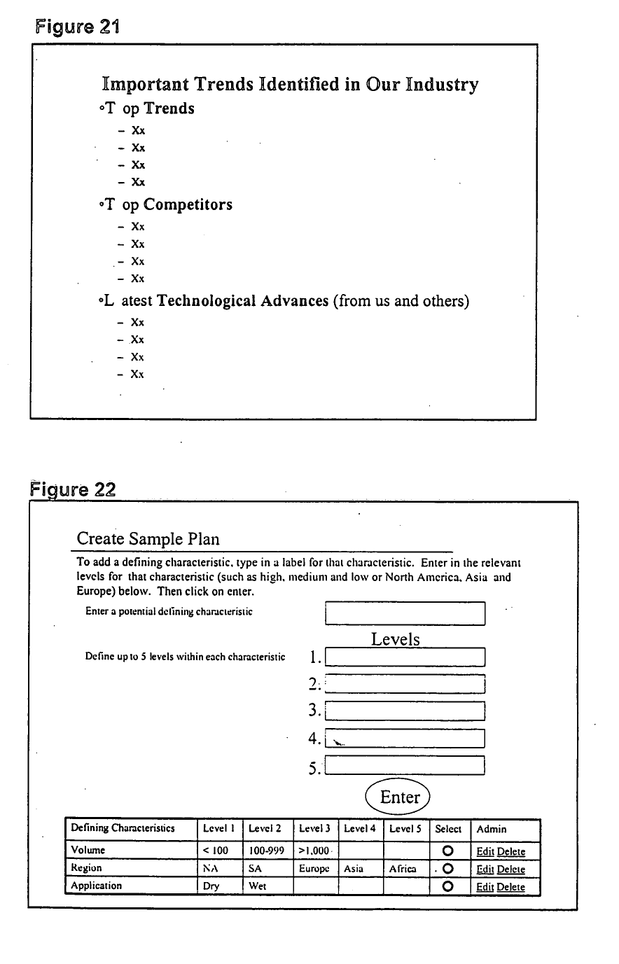

Finally, survey reports are generated (step 422) to complete the preparation for the kickoff meeting. Reports generated for each survey tally answers to discrete questions (i.e. yes/no or multiple choice questions), while listing answers to qualitative questions individually. Unlike traditional web database applications that pull information into application-proprietary templates (that may or may not be able to be exported/imported into standard word processing applications), the system of the present invention preferably enables the user to port information queried from the system database directly into Microsoft Word-based templates or the like. The reporting mechanism functions as follows: stored procedures determine user validation/access to the requisite report, data stored in the report tables are queried, the queried results are stored in pivot tables, a COM DLL call (that manipulates Microsoft Word through a Microsoft-supplied API) is made, a Microsoft Word report template created by the administrator is opened, pivot table data is streamed into the report template, a temporary copy of the completed report is saved as a Microsoft Word document type in a folder, on a specified server, which is then served (through a new browser window opened on the requester's computer) by the system's asp page. Although not described in further detail hereinafter, this same process is preferably used by the system for all reporting functionality. A screen shot reflecting a portion of the output from an exemplary survey report is shown in FIG. 21.

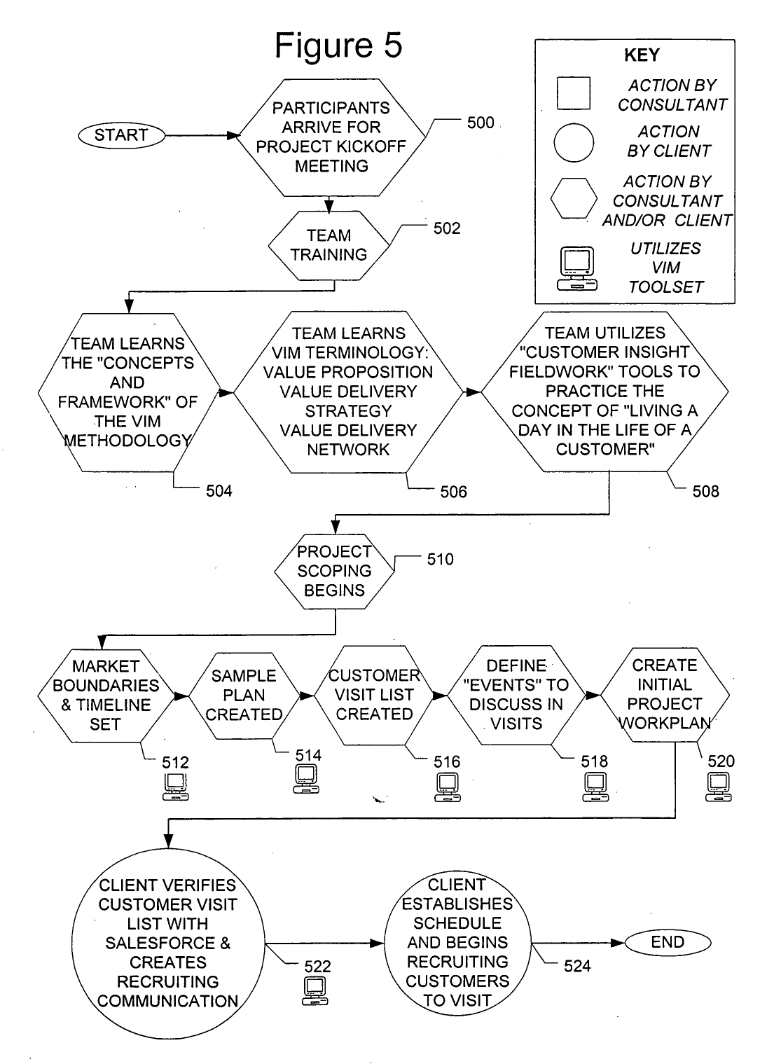

Turning now to FIG. 5, the steps performed at a project kickoff meeting are shown. The general steps of arriving at the meeting (step 500), having team training (step 502), learning the methodology of the system and project “pre-scoping” (steps 506, 508, 510) are conducted manually by participants. Although these steps do not involve the computer application of the present invention, they are nevertheless important because they provide the team with fundamental insights that enhance the results obtained from the remaining steps of the invention. For example, it is during these steps that the team learns a unique way of understanding the customer: instead of “listening to the customer,” they learn to “become the customer”—a concept that, while on the surface seems to be simple, is in fact a much more challenging task to accomplish in reality. Creating a practical implementation of this concept is important to remaining aspects of the invention. For example, unlike other market research tools and methods known in the art, this process does not rely on the customer to provide (often incomplete and almost always inaccurate and unprofitable) information about their wants and needs but instead focuses on gaining an in-depth understanding of actual customer experiences (historical and current events, hereinafter referred to jointly as “current events”) as a basis for developing new insights about what value will be required today and in the future to win the business of the client's current and prospective customers.

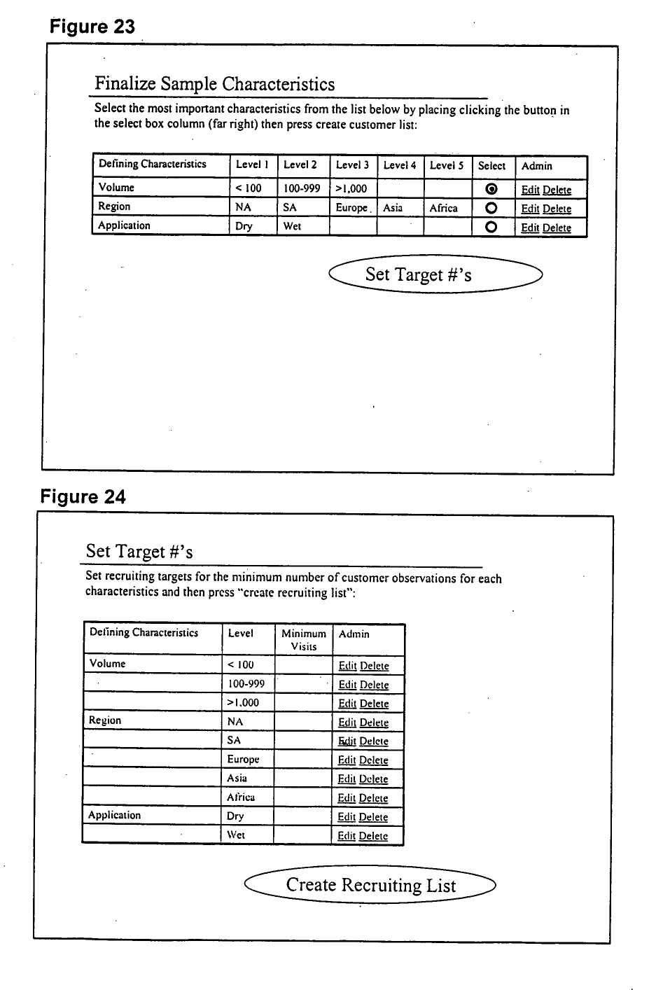

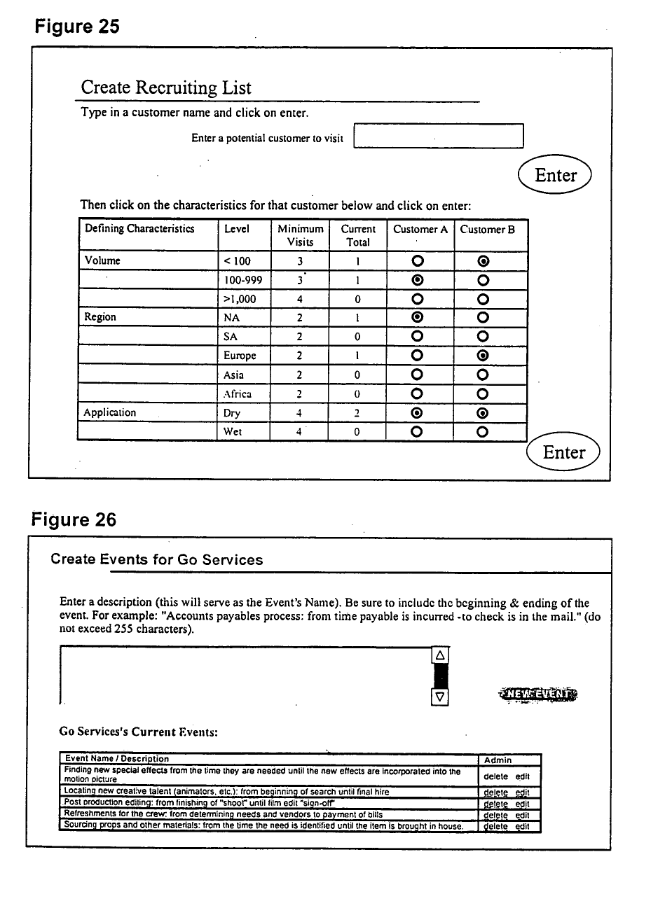

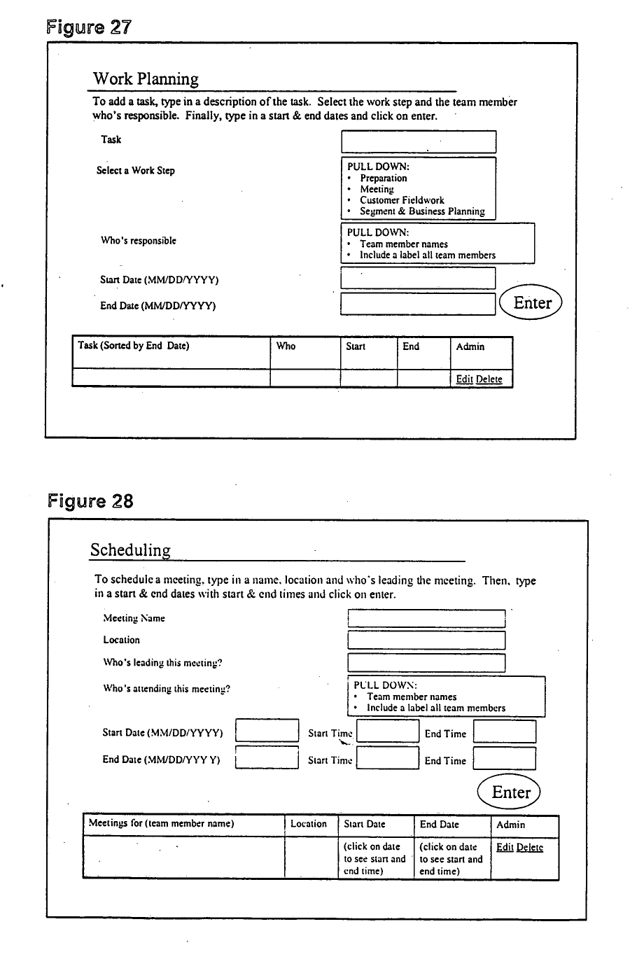

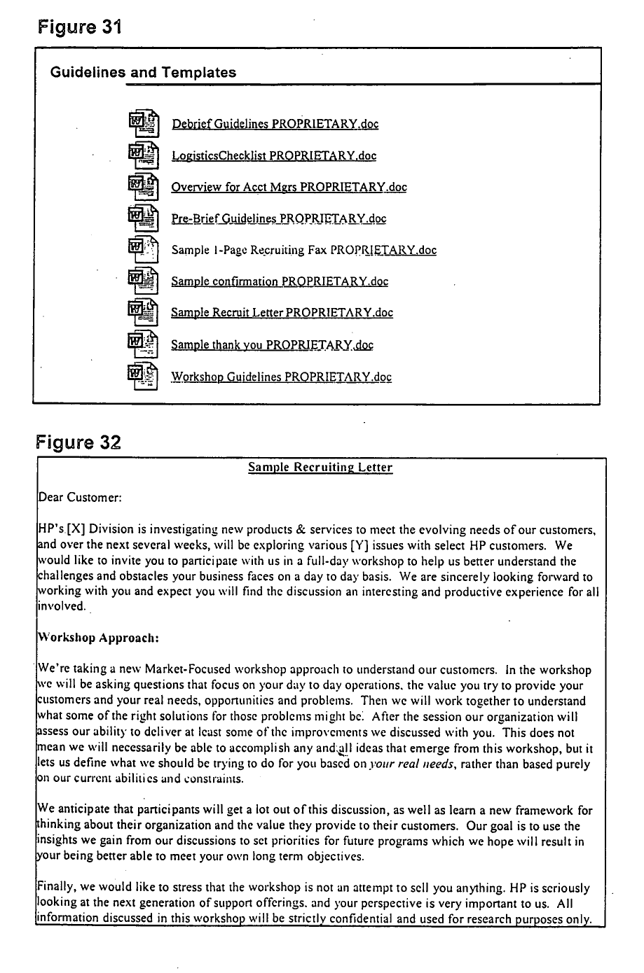

At the conclusion of the training, project scoping begins (step 510). As part of the project scoping, market boundaries and timelines are set (step 512), a sample plan is created (step 514) (see also FIGS. 22-24), the customer visit list is created (step 516) (see also FIG. 25), current events or topics for discussion at the visits are determined (step 518) (see also FIG. 26), an initial workplan is created (step 520) (see also FIG. 27), and the sales-force is engaged to validate the chosen customer list (step 522). FIGS. 31 and 32 illustrate a list of documents useful for project scoping along with a sample recruiting letter to send to a customer. While the majority of this activity is accomplished via standard database stored procedures and tables using business rules aligned to the system's process, there are several functions performed by the system during the project kickoff that are described in greater detail below.

For example, in the preferred embodiment, the sample plan created at step 514 and as illustrated in FIGS. 22-24, allows the user to hypothesize characteristics that describe a potential customer (e.g. region of operations), designate various levels that separate a characteristic into discrete, distinguishable components (e.g. North America, South America, Europe, Asia, Africa), set target recruiting numbers for the levels within each characteristic, and then create a matrix sample plan, enabling the user to input potential customer names and map them to the required characteristics.

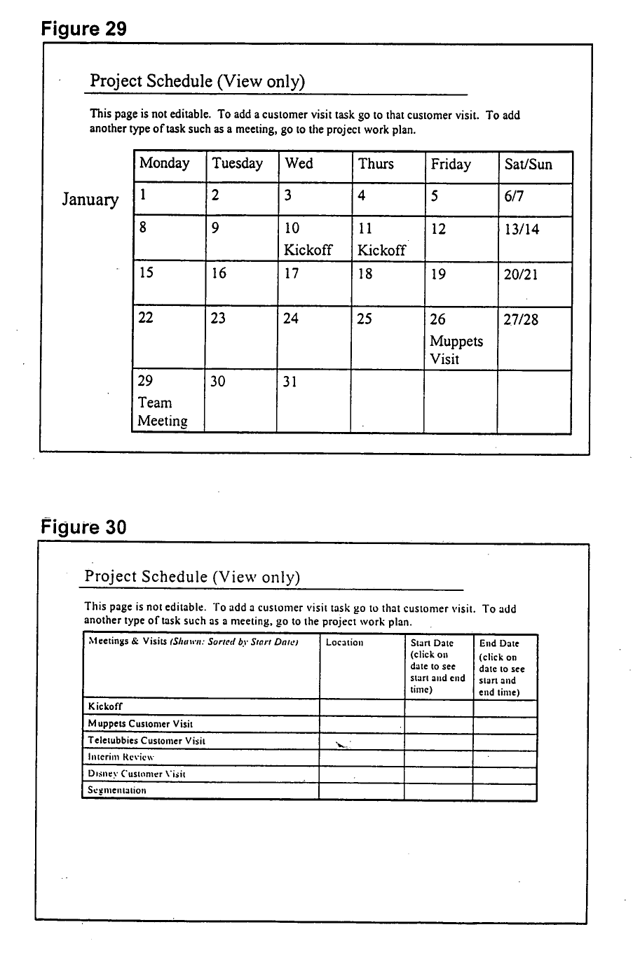

Next, the step of creating a project schedule (step 524) allows the user to enter tasks, meetings, milestones, etc. and view the information in the form of a calendar imbedded directly within the system of the present invention. This enables the users to keep the analysis on time and on budget by tracking progress against both system-derived and user-defined required tasks. In the preferred embodiment, the system provides project schedule functionality using an Active X application commercially available from a company called Infragistics Inc. Screenshots reflecting the creation of the project schedule are illustrated in FIGS. 28-30.

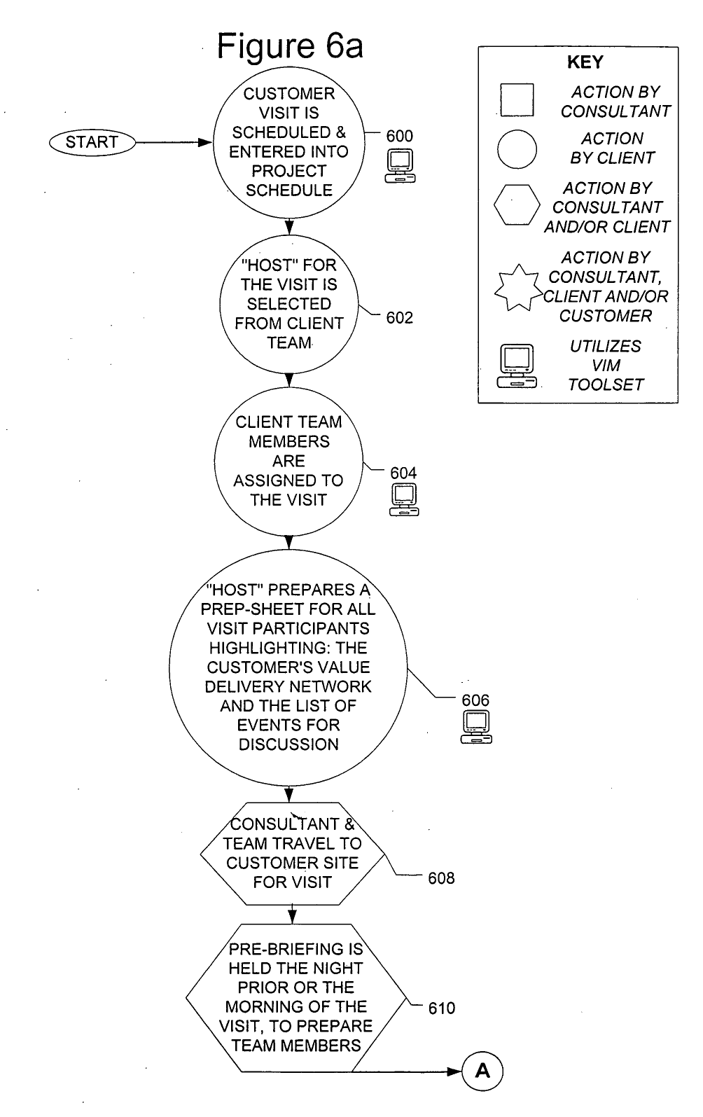

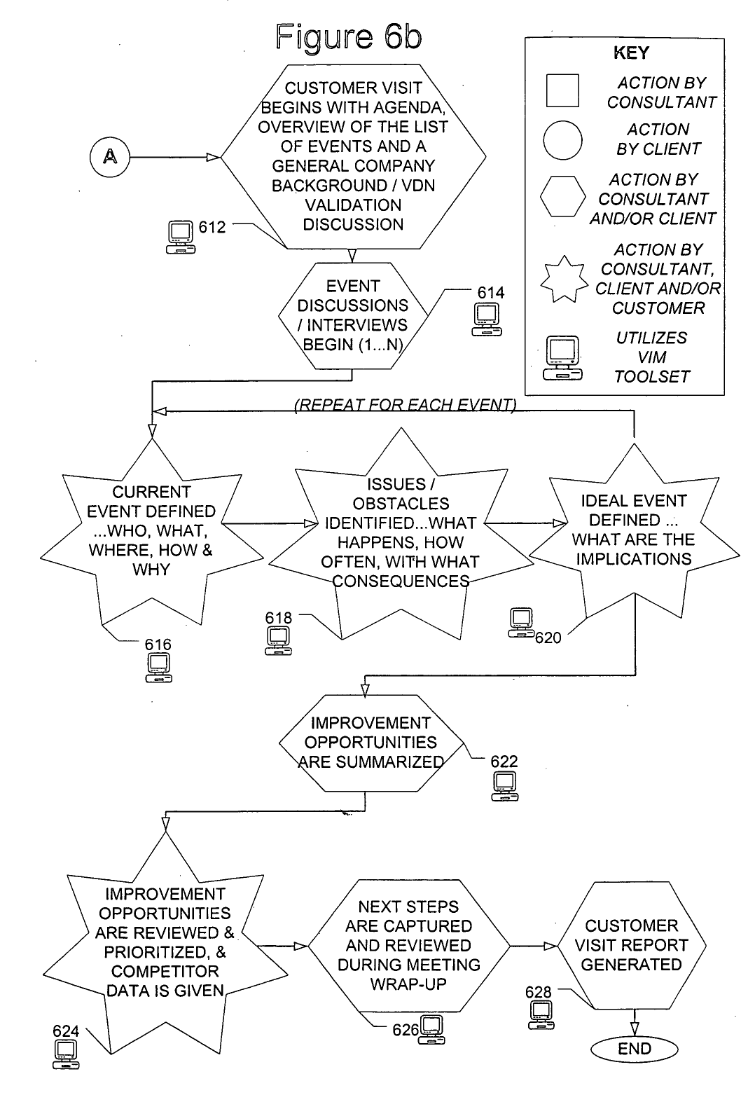

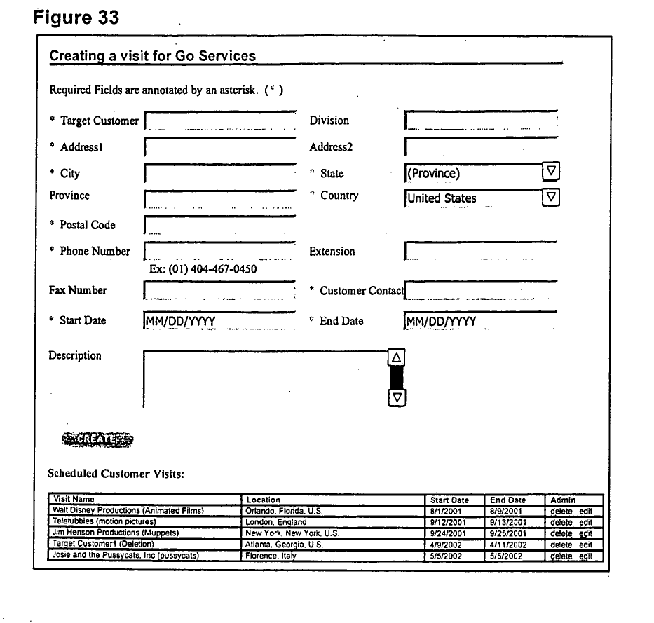

With reference now to FIGS. 6a and 6b, the process of implementing a customer visit is illustrated. First, a visit is scheduled (step 600) and setup in the system. Creating a customer visit within the system is generally accomplished via the same database functionality as the creation of a project or a customer (described previously). As before, an information summary table is available to facilitate edit and delete capabilities. Once a visit is created, it will appear on the project schedule (described above). This provides all team members (as well as senior management) the ability to access a single, centralized location to view all scheduled project activities. A screenshot reflecting this can be viewed in FIG. 33.

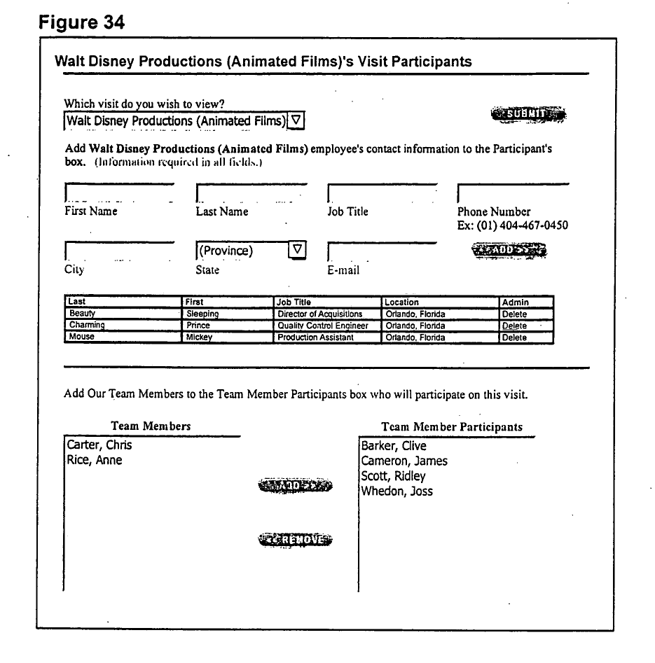

After a “host” or visit lead is selected (step 602), project team members are then assigned to the visit (step 604), as illustrated in FIG. 34. To add team members, the user clicks on the name they wish to add (in the box on the left) and selects “add.” The name will appear in the “team member participants” box on the right hand side. To remove a team is member from the participant box, the user clicks on the name they wish to delete and selects “remove.” This will not delete team members from the project—only from the visit list.

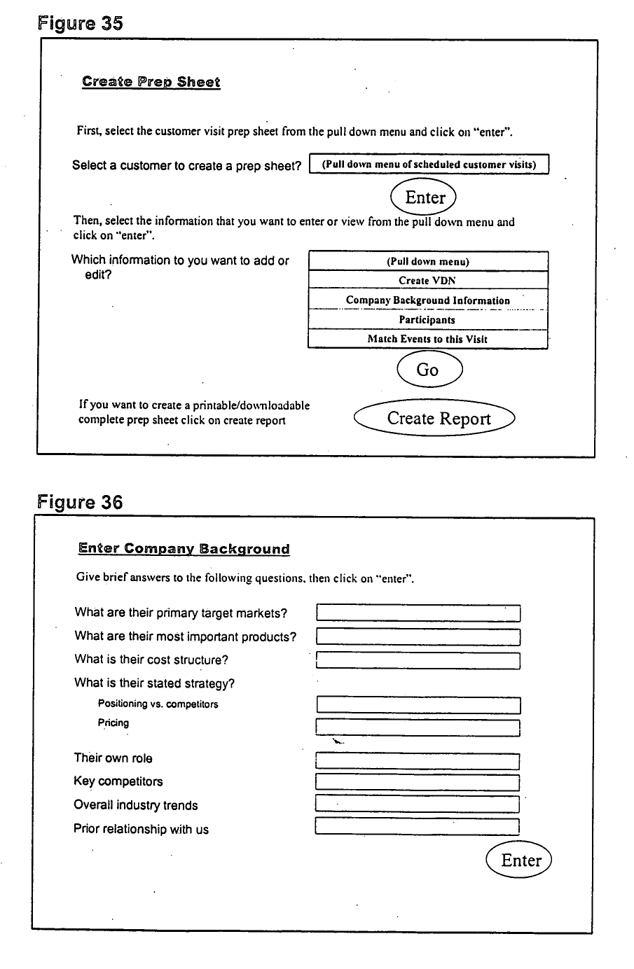

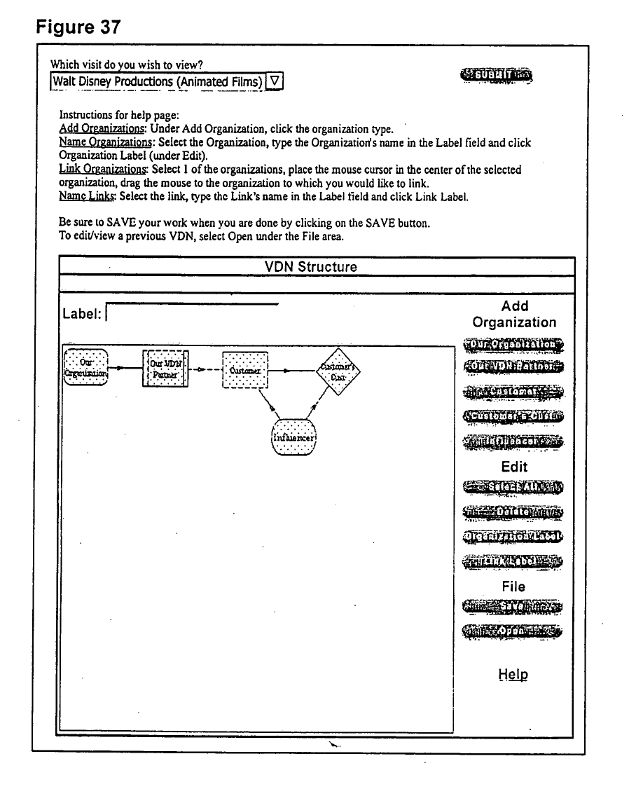

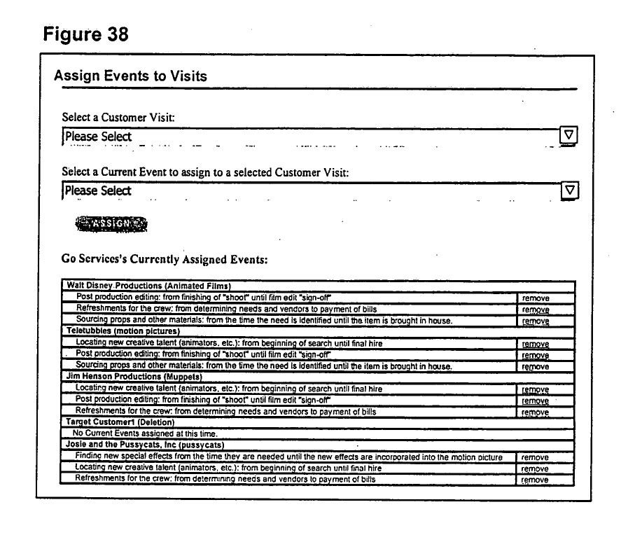

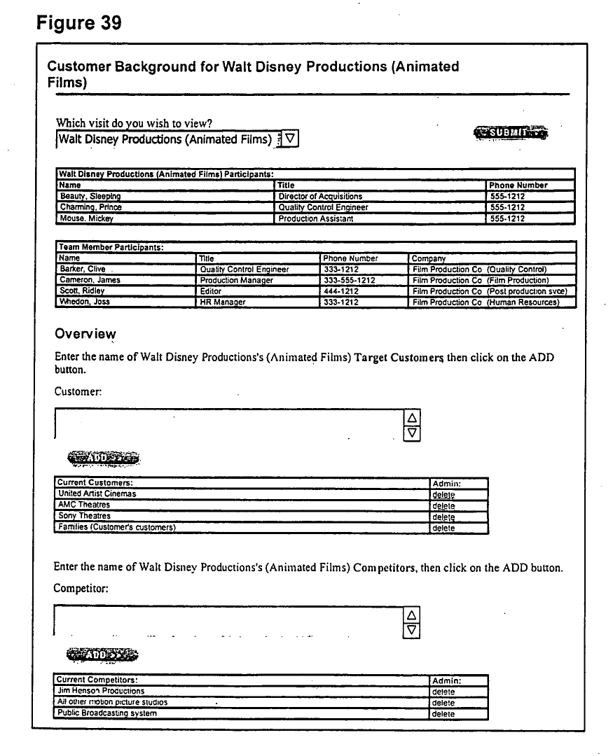

The final task to be accomplished by the user prior to attending a visit is the creation (step 606) of a customer “prep sheet,” where the user documents a VDN for the customer and selects the events to be discussed at that particular visit. Organizing the data collection around these “events” is an important step. In prior art systems, cross-functional teams usually collect inconsistent data making the analysis vastly more time consuming and invariably inaccurate. This functionality has been described previously and is easily understandable by anyone skilled in the art. Screenshots reflecting the user's view of this functionality are illustrated in FIGS. 35-38.

Although some market research methodologies request the participants to complete some sort of preparation prior to visiting a customer, there is no formal process documented in any known prior art systems that ensures consistent careful preparation. The invention leads the user through a step-by-step process, which facilitates thorough investigation of the customer (e.g. who are their primary clients; who are their competitors; what, if any has been their past and current experience with the user's firm, etc.) prior to the visit, ensuring that the customer as well as the user views the visit as a positive, professional experience. After the preparation is complete, the team travels (step 608) to the customer visit location and hosts (step 610) a “pre-briefing” meeting, preferably, the night prior to the visit.

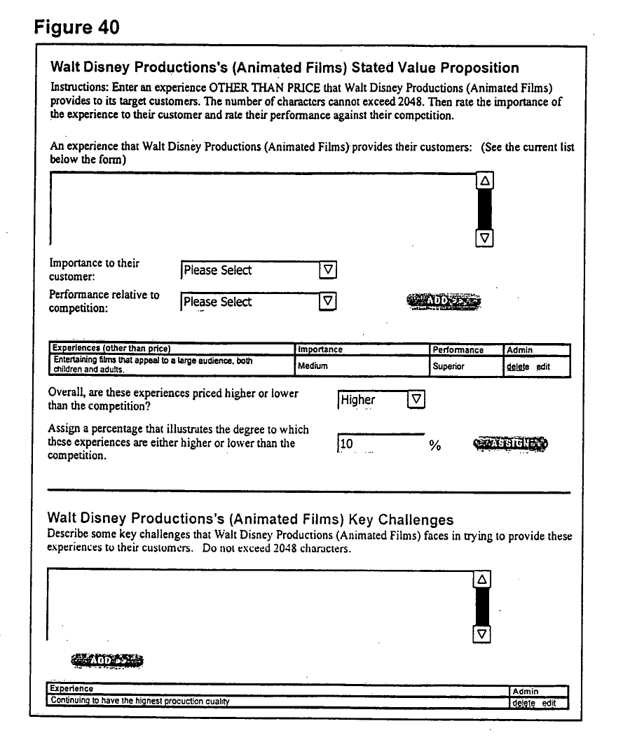

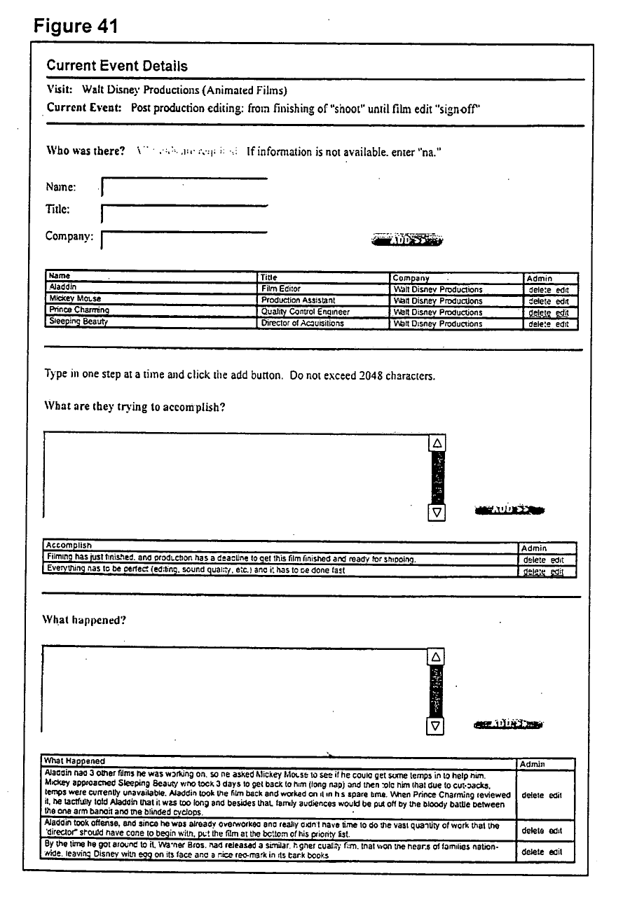

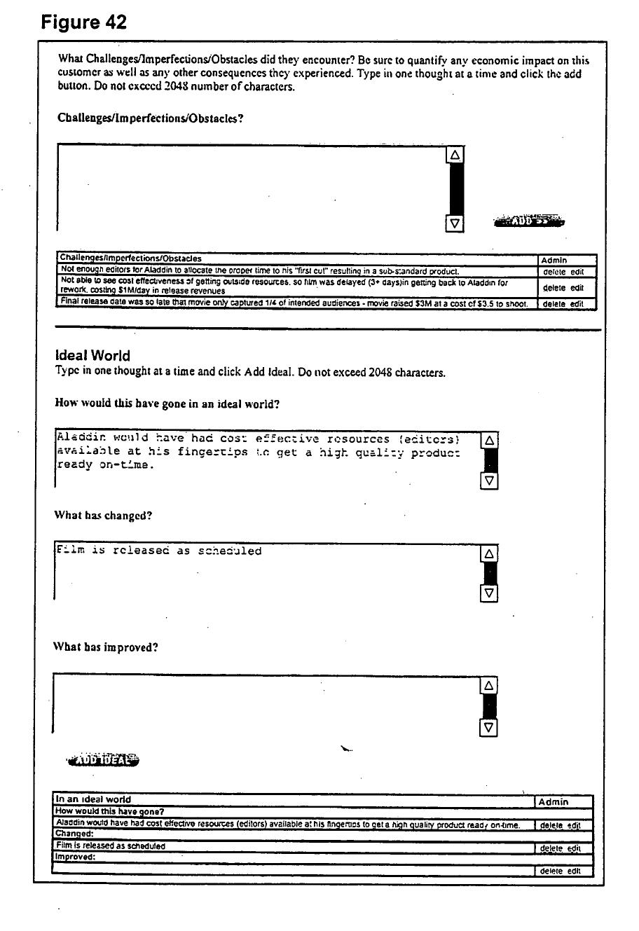

At the beginning of a customer visit, background information specific to that customer is entered (step 612) into the system. This basic database input functionality is reflected in the screenshots shown in FIGS. 39-40. Discussion (step 614) of each current event or “day in the life” experience is an important aspect of the methodology of the present invention and takes place in three parts (steps 616-620). First, the customer selects (step 616) a recent or typical example of each experience and then describes it as if it had just occurred. The user enters this information into the system, making sure to note the actions taken by the customer. As each step is described, the user records the information in the system. Detail here is important. The user then queries (step 618) the customer on specific challenges encountered during this event, noting any impact (economic and other) these challenges had on the customer's experience. Again, this information is input into the system. Finally, the customer is questioned (step 620) on their “vision” of a “perfect” event, and is asked to describe what that “ideal” event, had it occurred, would have looked like. The user inputs a description of the customer's “ideal event” as well as the changes/improvements that would have occurred if this “perfect” event had occurred. These steps are repeated for each event to be discussed at the visit. Unlike existing market research tools and methods that ask the customer questions about their needs and desires, the present invention explores the customer's current experience and events to develop insights about what value will be required today and/or in the future. These insights are based on a detailed understanding of the customer's experiences, the consequences of those experiences, and both the economic and intangible value of those experiences to the customer. The event detail queries are reflected in the screenshots shown in FIGS. 41-42.

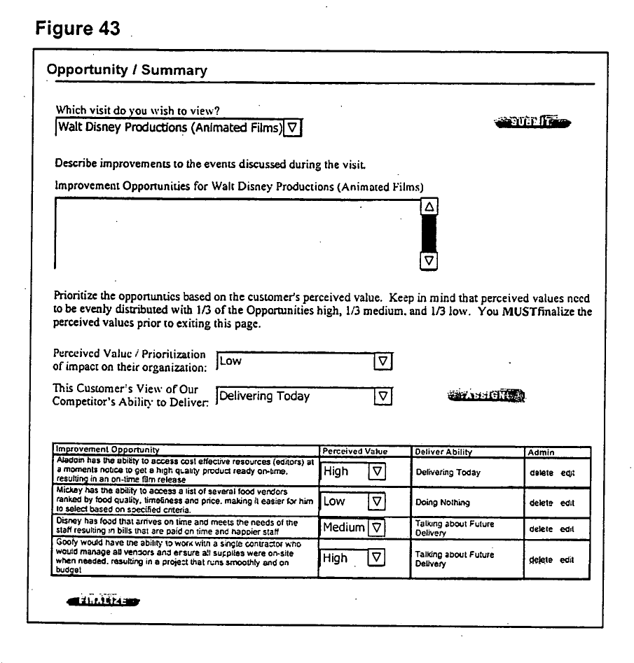

The next task to be accomplished at the customer visit is the opportunity summary. The user identifies (step 622) a potential improvement opportunity, assigns a priority (high, medium or low) from a pull-down menu and estimates their competitors ability to deliver this opportunity. This occurs without the customer's input. The customer then reviews all opportunities and validates the prioritization (step 624). The system preferably requires the user to assign ⅓^{rd} of the opportunities a high priority, ⅓^{rd} medium, and ⅓^{rd} low. This is accomplished via a mathematical algorithm within the stored procedure that calculates the number of entries and forces the user to maintain an equal number of priorities prior to “saving” the information. The algorithm is capable of flexibility in the event that a mathematically-balanced solution is not available due to the number of entries input. A screenshot reflecting the creation and prioritization of improvement opportunities is illustrated in FIG. 43. Once again, the system forces the user to analyze more thoroughly the information. The fact that this is a jointly-developed prioritization (assigning of priorities initially by the user and then validated by the target customer) is an advance over the prior art systems.

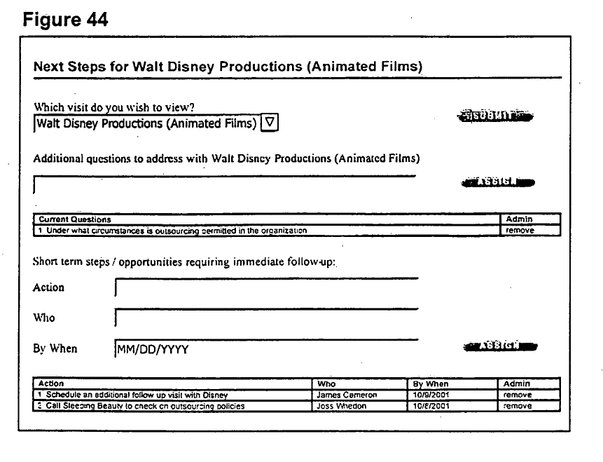

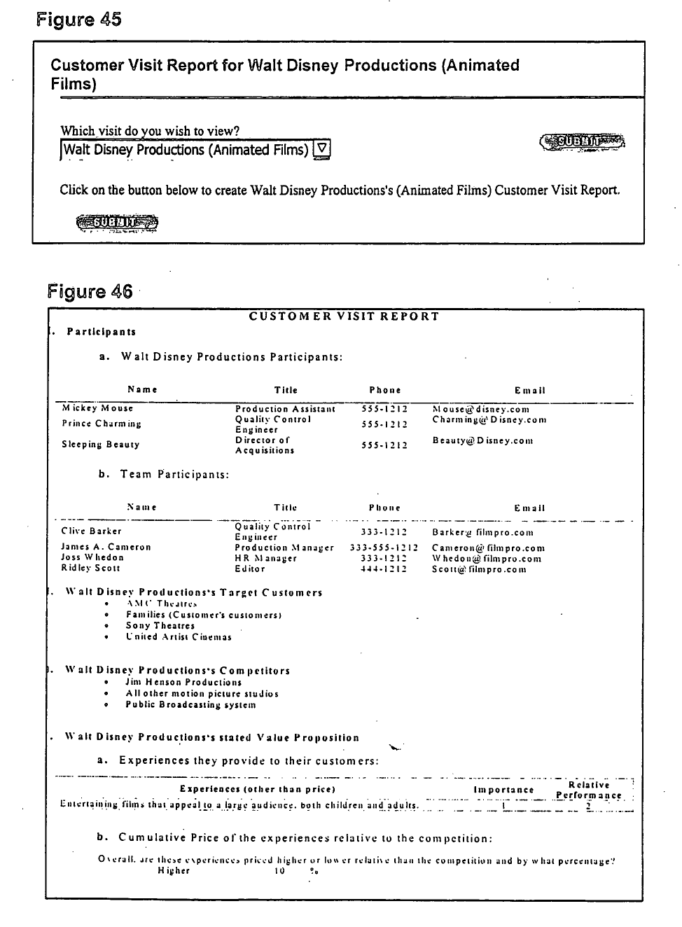

Finally, “next steps” from this visit are documented (step 626) and a visit report generated (step 628). From the user's perspective, adding “next steps” is a simple task of entering the action item, assigning an individual to be responsible for follow up, and selecting a due date (as shown in FIG. 44). The invention records the data and then transfers this information to the project schedule (described previously). After all “next steps” have been documented, the user then generates a customer visit report detailing all the information captured during the visit. The technical functionality required to generate this report is the same reporting mechanism described previously; however, the data is specific to the event (Customer Visit) as is the document template utilized to build the report. Screenshots reflecting the creation of a customer visit report and an abbreviated snapshot of the output from a report are illustrated in FIGS. 45-46.

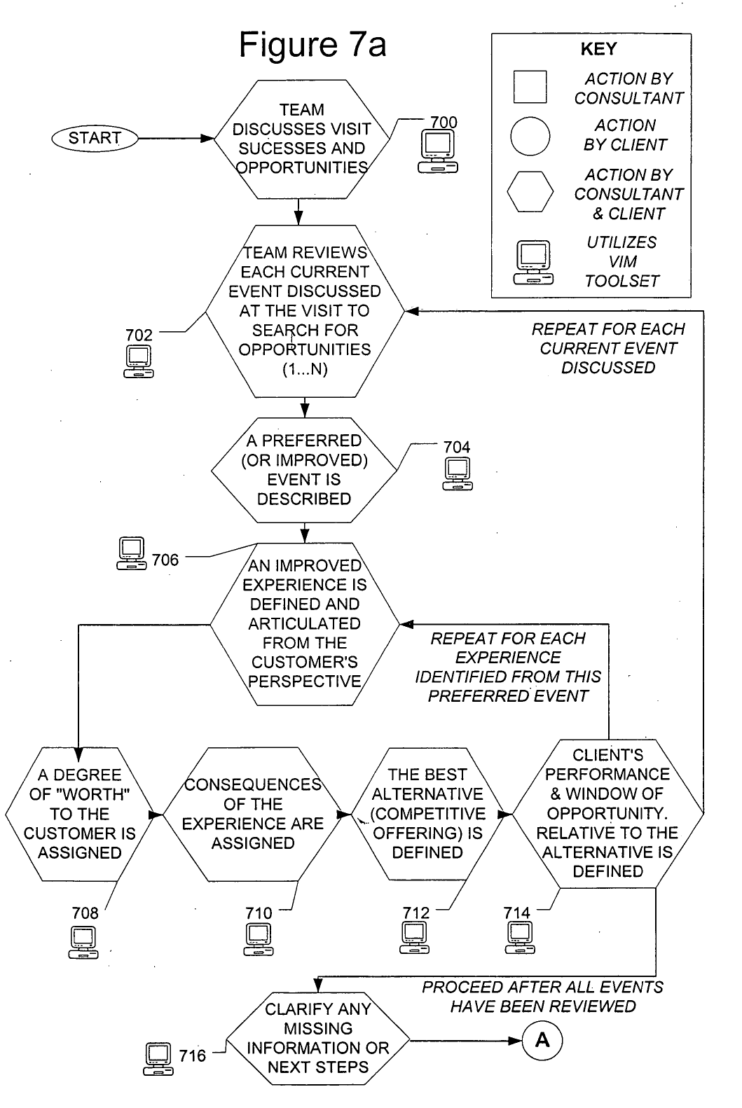

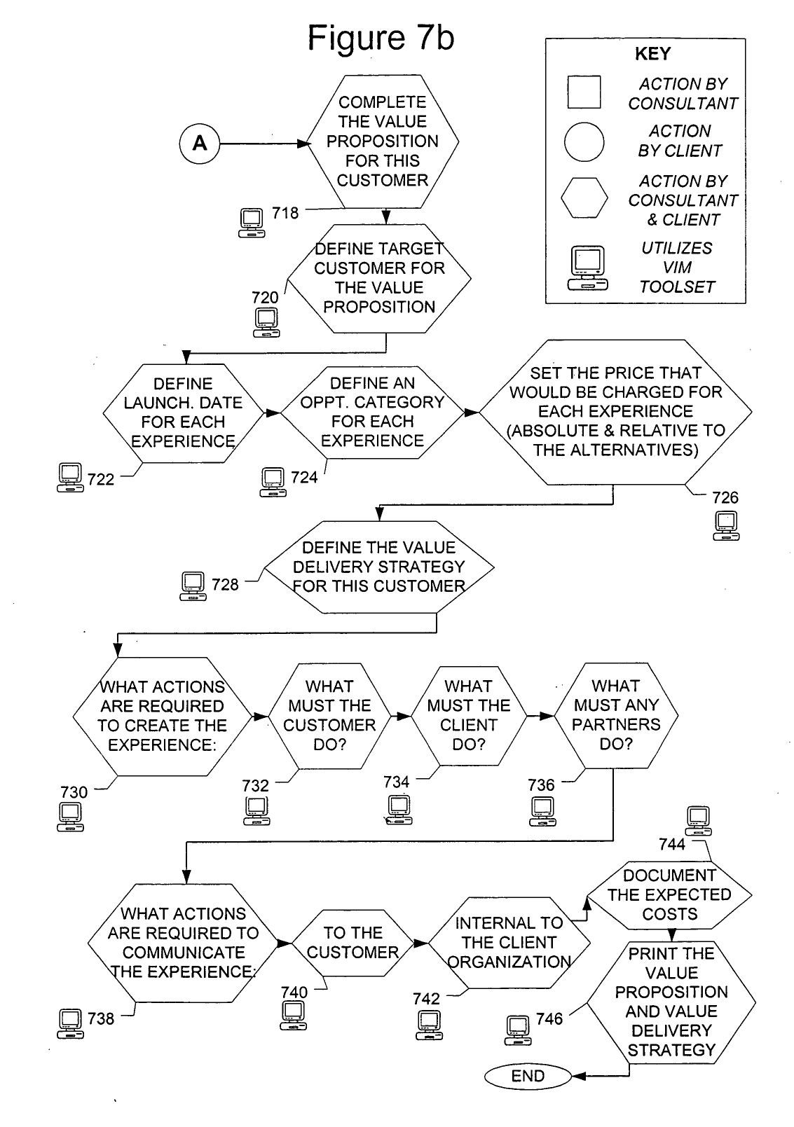

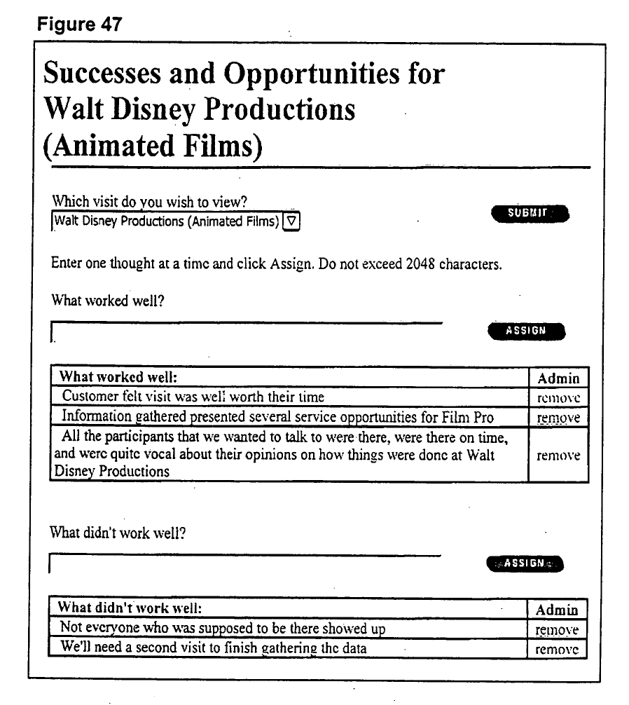

At this point, as illustrated in FIGS. 7a-7b, the user leaves the customer site and the visit debrief begins. Visit successes and opportunities for improvement are documented (step 700) (see also FIG. 47), and then the customer analysis/preferred event discussion begins (step 702). The team selects an event that was described by the customer, and then describes it as a “preferred event,” one that has been improved by the team within an established time horizon (step 704). This is then articulated as an “improved experience,” written from the customer's perspective.

This “step-by-step” process utilized to analyze customer data is a distinctive capability that is an important aspect of the present invention. Unlike existing market research tools and methods that begin their analysis by asking the user “based on what you've heard, what products and services do you want to make,” the invention begins the analysis by asking “based on what you've heard, what experience do you want to enable the customer to have.” This is a subtle, but critically important difference. By requiring the user to visualize an improved experience for the customer, this broadens the user's perspective to consider multiple strategic options for delivering upon that improved experience, and provides them with the opportunity to choose the solution that is both profitable for them, and a win for the customer . . . products and services become simply a means to an end. The detail captured in the improved customer experience is an important component that enables the user to develop comprehensive functional requirements. This detail is missing in the prior art.

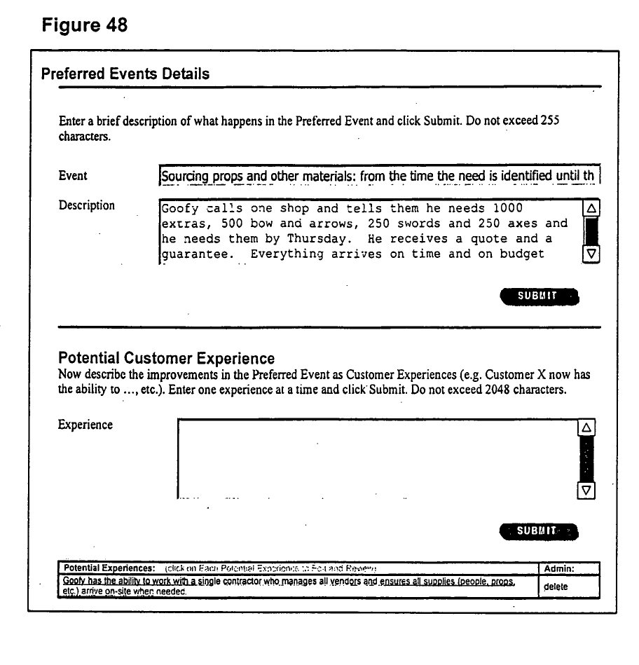

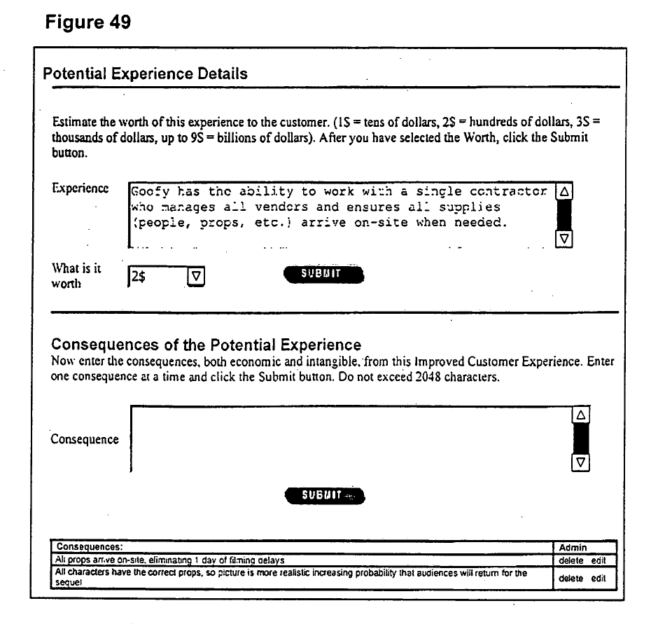

After all experiences have been entered, the user then selects (step 706) a single experience to explore in more detail. Upon selecting the experience, the application returns a screen to the user respective of the “improved experience” with additional fields required for user input. The user assigns (steps 708, 710) a “worth” to the customer of this experience (via a pre-populated pull-down menu), as well as the consequences to the customer were this event to occur. The system utilizes a unique approach to assign “worth” to a customer experience. The goal at this point of the process is to assign an “order of magnitude” number to reflect the value to the customer of providing the experience using a 9-point scale. In a preferred embodiment, the scale represents order of magnitude in multiples of 10 (i.e. is it worth hundreds of dollars, thousands, tens of thousands, millions, etc.), but the scale can represent any increment upon which the users agree. The system preferably uses scientific notation to represent these values. For example, thousands of dollars (or 10³) is represented as 3$; millions of dollars (or 10⁶) is represented as 6$, etc. The means by which this information is entered is via basic database input functionality (described previously), and is reflected in the screenshots shown in FIGS. 48-49.

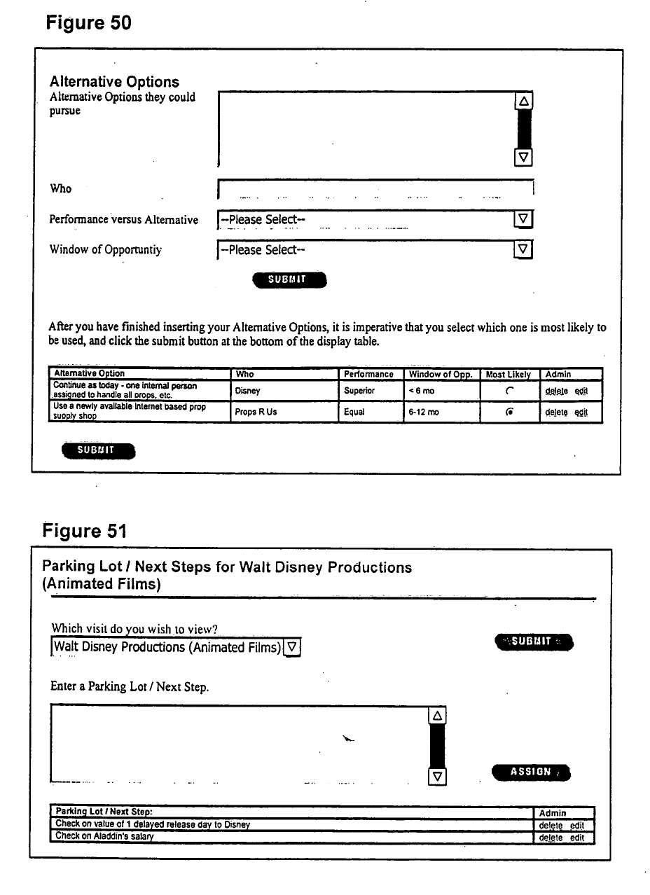

As shown in steps 712-714 (and reflected in the screenshot in FIG. 50), the user then defines the best alternative to each improved experience created by the team, answering the question “If the customer does not pursue this experience with us, what is the most likely alternative they will pursue?” Again, rigor and thorough analysis are ensured by this system because the user is compelled to enter not only the alternative action, but also the vendor who would provide it, believed performance compared to this vendor, and the window of opportunity for which this performance can be sustained. This is an important distinction because the prior art focuses only on the current provider and/or on the value of a customer experience in absolute terms (but not relative to each competitor). This is repeated for as many “realistic” alternatives as can be identified, and then the “most likely” alternative is chosen via a radio-button. The team then begins this process again for the next current event described by the customer, until each preferred event has been explored in detail. Finally, any missing information/follow up questions are documented as parking lot issues/“next steps” (step 716) (see also FIG. 51).

A debrief report is then generated using database standard calls. This is different from the reporting mechanism used for other aspect of the present invention in that the COM DLL normally used that manipulates Microsoft Word is not utilized. Instead, the database is queried, the information is stored in pivot tables, and subsequently displayed using DHTML to the user via the browser.

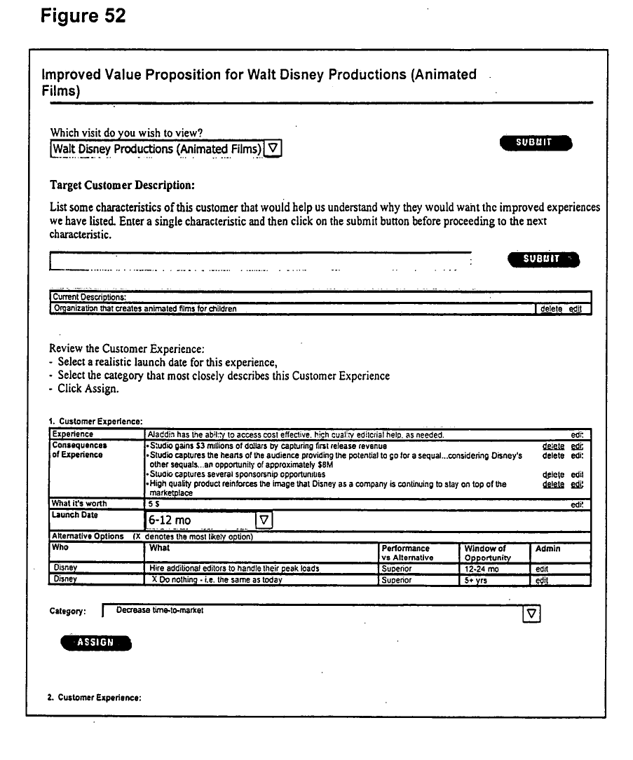

To complete the analysis, the users develop (step 718) a value proposition and value delivery strategy for the customer visited. To begin, the user enters characteristics that both help describe the customer and assist the team in developing an understanding as to why they would desire the experiences created by the team (step 720). For each experience, the user selects (step 722) a realistic launch date (when could the team begin delivering this experience) as well as a customer experience category (a summary of the bottom line benefit of this experience) (step 724). Both of these assignments are made via previously defined pull-down menus, the implementation of which are known to those skilled in the art, and can be viewed in the screenshot illustrated in FIG. 52.

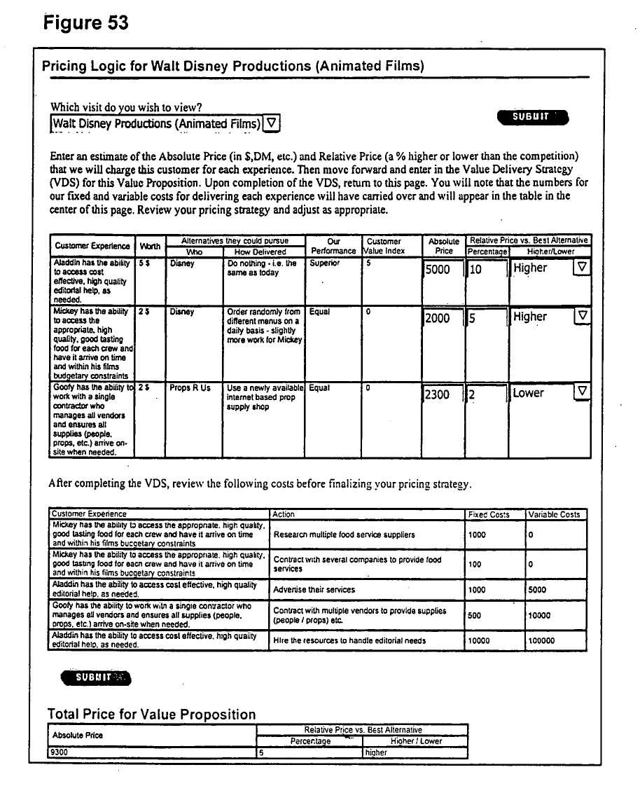

The user then defines (step 726) the price they will charge this customer for this value proposition. While this is an iterative process, the system requires the user to enter an absolute price they would charge the customer for each experience in the table, as well as a relative price, a % higher or lower than their alternative would charge. Calculation of the total price for the valuation is done by the system using a stored procedure to implement two formulas: a simple mathematical summation for the absolute price and a weighted average for the relative price. The total price is displayed at the bottom of the screen, and can be viewed in the screenshot shown in FIG. 53. None of the prior art enables the user to analyze pricing by customer experience.

Next, the system enables the user to efficiently translate customers' value requirements into a comprehensive clearly defined “value delivery strategy,” detailing all the organizational and functional business requirements to deliver the value to a specific target customer. These requirements include definitions of new products and services, as well as refinements on existing products and services. The value delivery strategy portion of the invention consists of two components: defining (step 728) how each experience will be created for the customer and defining (step 730) how each experience will be communicated to the customer and the user's organization. The system's ability to accept simultaneous multi-user input enables users with different backgrounds and expertise to convert customer value requirements into a more comprehensive set of functional requirements than any one individual could do by themselves.

In order to create each experience for the customer, three entities must work together—the user's organization (client), the customer organization (customer), and any value delivery partner they choose to work with; therefore, what each organization must do to help “create” this experience must be defined separately. The user begins by selecting the experience they wish to define as well as one of the entities in the pull-down menu. This is another critical distinction in the database structure. By analyzing one customer experience at a time, users create more detailed solutions that they do when they try to analyze all customer experiences simultaneously. In addition, this customer-experience-specific analysis allows the user to eliminate an unprofitable customer experience later in the analysis and have the remaining analysis unaffected. Thus, strategic decision-making can be more fluid and fine-tuned over time, and the communication of required functional changes is dramatically accelerated over the prior art.

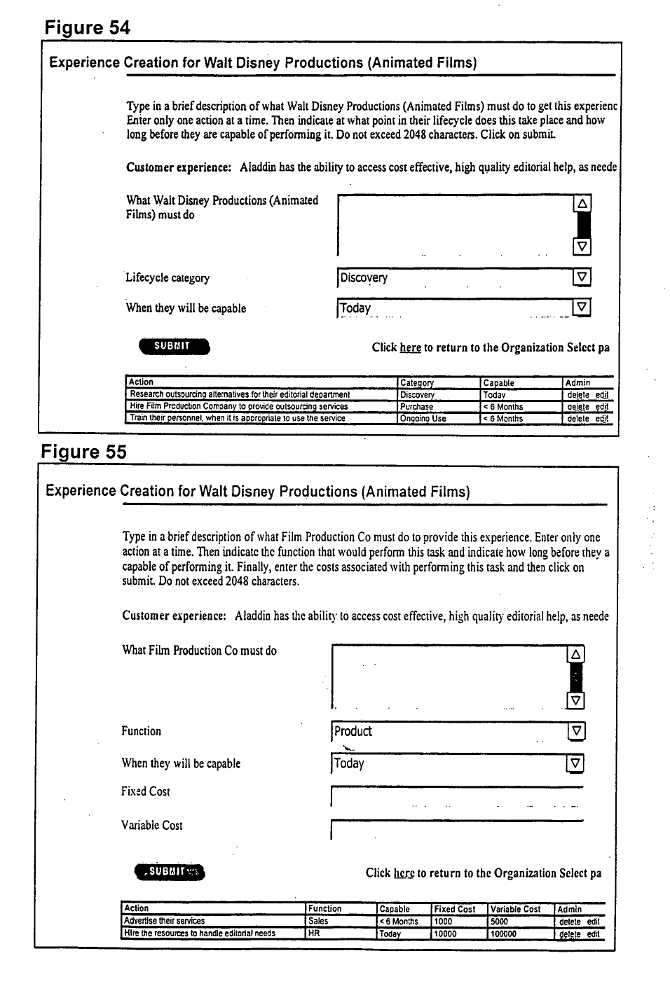

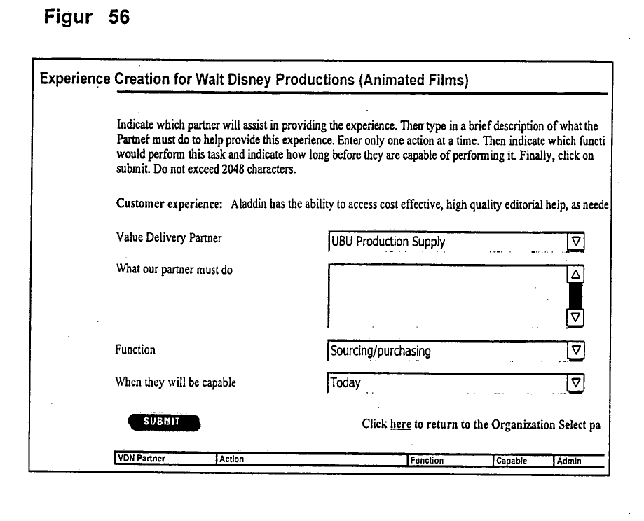

Depending on the entity chosen, the appropriate questions will be sent to the user (as shown in steps 732-736). The invention accomplishes this via a stored procedure with “CASE” logic that determines the appropriate constraints based on the user selection (organization, customer organization, value delivery partner) and subsequently passes the appropriate values back for population of the drop-down selection. After all questions on this page have been answered (including the estimated cost for this entity to provide the experience), the user then defines the other entities' actions. After all entities actions have been defined for the first experience, the user repeats this process for subsequent experiences. The user actions required to complete these tasks are illustrated in the screenshots of FIGS. 54-56.

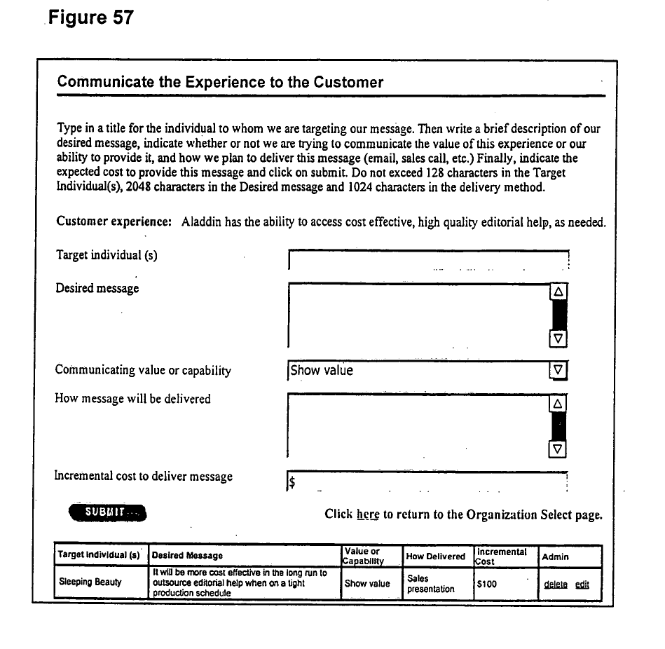

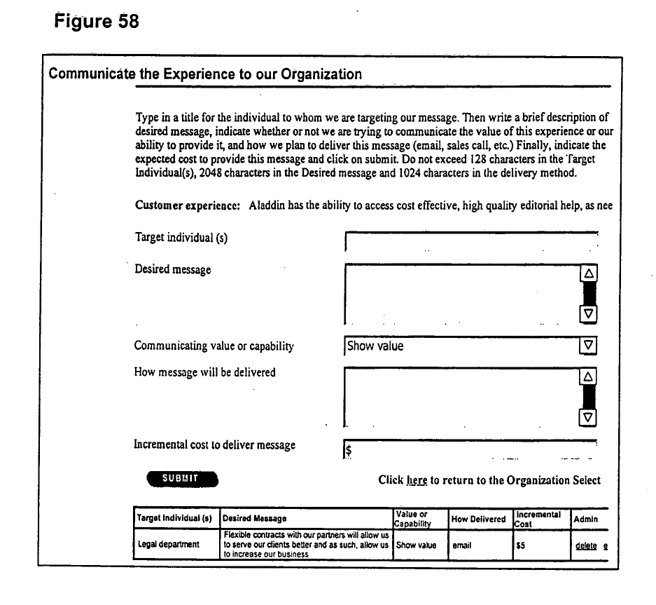

Defining the communication strategy for each experience is a similar process to the one described in the previous paragraph. Each experience has to be communicated not only to the customer but to the user organization as well; therefore, how the team will “communicate” each experience to each organization is defined separately. Developing a communication strategy (step 738) by customer experience for both the customer and the organization simultaneously is a feature of the present invention. The user begins by selecting the experience they wish to communicate as well as one of the entities in the pull-down menu. Depending on the entity chosen, the appropriate questions will be sent to the user (steps 740-744). The same logic is utilized as described above for steps 732-736; however, a different stored procedure is responsible for the activity. After all questions on this page have been answered (including the estimated cost for this entity to communicate the experience), the user then uses the link “Return to the Organization Select Page” to define the other entities' actions. After all entities actions have been defined for the first experience, the user repeats this process for subsequent experiences. The user actions required to complete these tasks are illustrated in the screenshots in FIGS. 57-58.

Once ALL experiences have been Created and Communicated, the user returns to the VP pricing page. This is reflective of the invention's unique iterative capabilities, in that it provides the user with the opportunity to readjust the pricing for their value proposition, after all the costs for creating and communicating it have been determined.

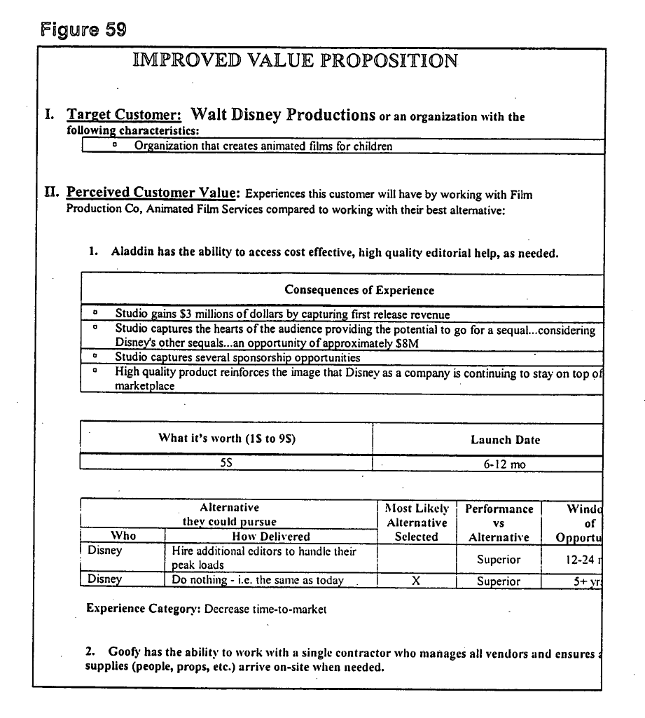

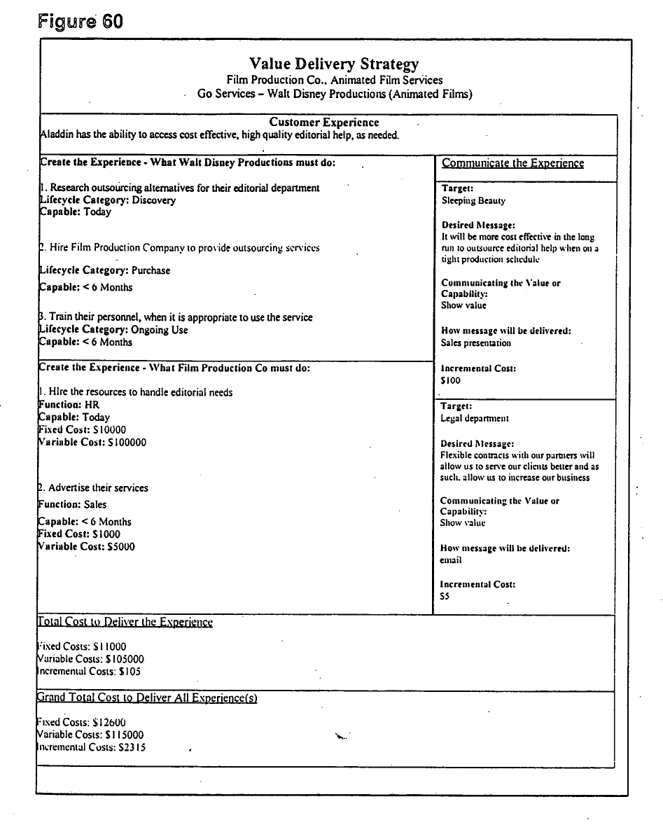

Finally, a value proposition and value delivery strategy report for this visit are generated (step 746). The user chooses the customer for whom they wish to create a report and submits this information. The invention correlates and extracts project-specific data across numerous tables constrained according to rules relevant to the business process, and a report is generated using the same reporting mechanism as previously described to create a customer visit report. Screenshots reflecting a portion of the information displayed in the value proposition and value delivery strategy reports can be seen in FIGS. 59-60.

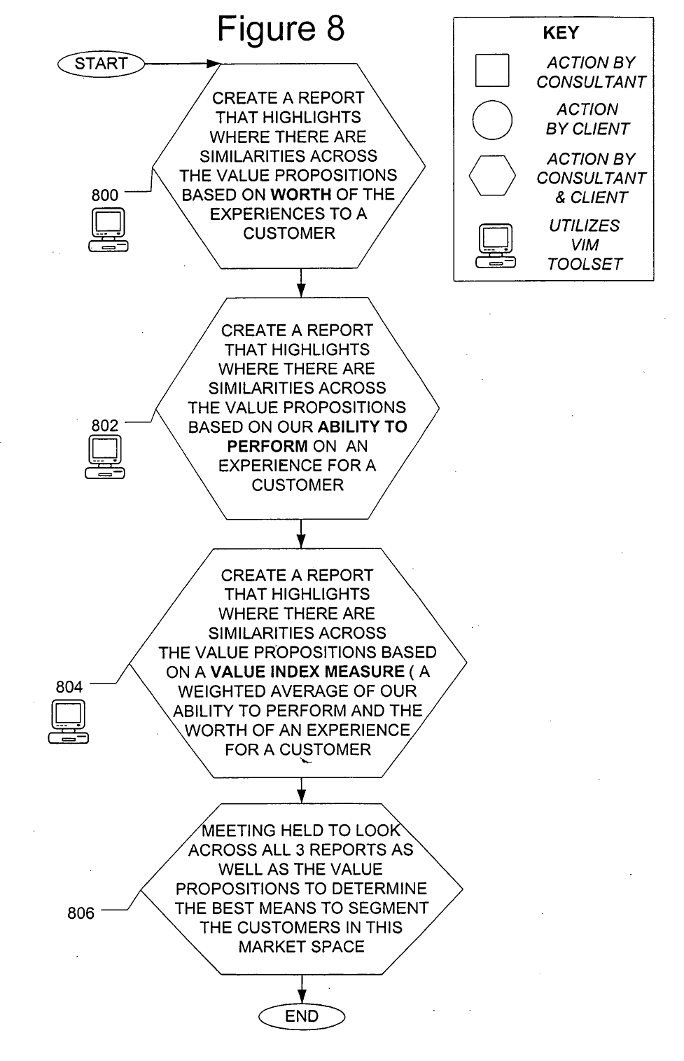

Turning now to FIG. 8, steps 800-804, there are three types of reports that are generated to help the user segment the market after two or more customer visits have been completed. Although marketing segmentation is often referred to as “more art than science,” it is here that the present invention departs again from systems currently known in the art. Rather than the more traditional method employed by other methodologies of manually sifting through stacks of information to try and see patterns that infer hidden segmentation groupings, the segmentation reports provide a quick, painless means of viewing all the information gathered in a concise, consolidated format. Patterns do not have to be created and developed . . . they can be clearly seen, and the resulting segmentation is as accurate as it is comprehensive.

To accomplish this, the user selects to view segmentation based on “worth to customer” (highlighting the experiences valued the same by multiple customers), “our performance” (highlighting the experiences where the team “performs” the same across multiple customers), or “value index” (highlighting the experiences that are the same across multiple customers factoring in both worth and our performance). These segmentation views are created by the worth rating, the competitive performance rating, and the value index (calculated by the invention using the formula, “value index=worth rating×competition performance”, where inferior competitive performance is rated a “−1”, equal performance is rated a “0” and superior performance is rated “+1”).

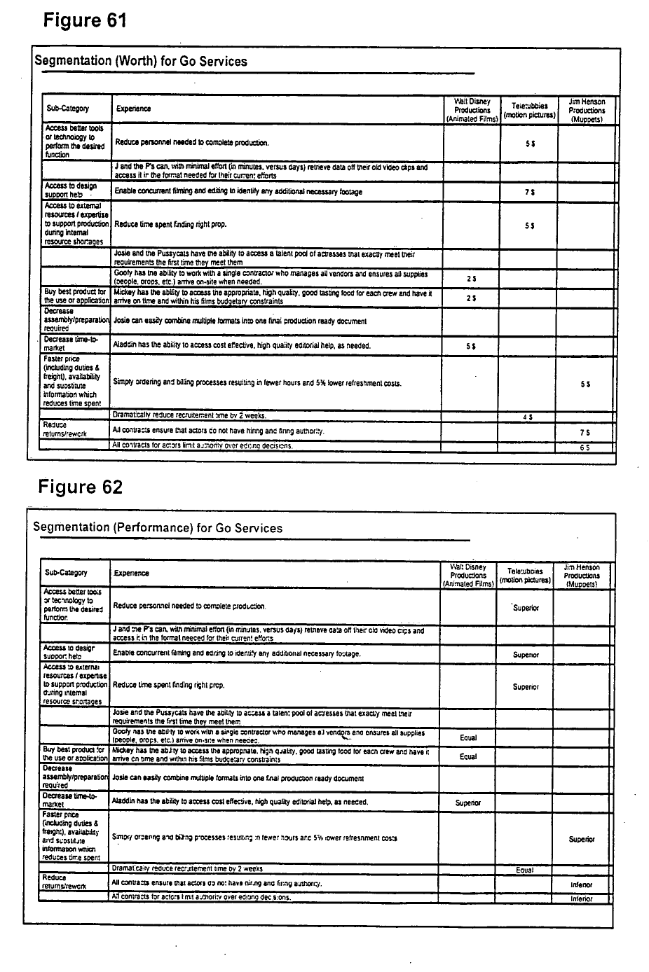

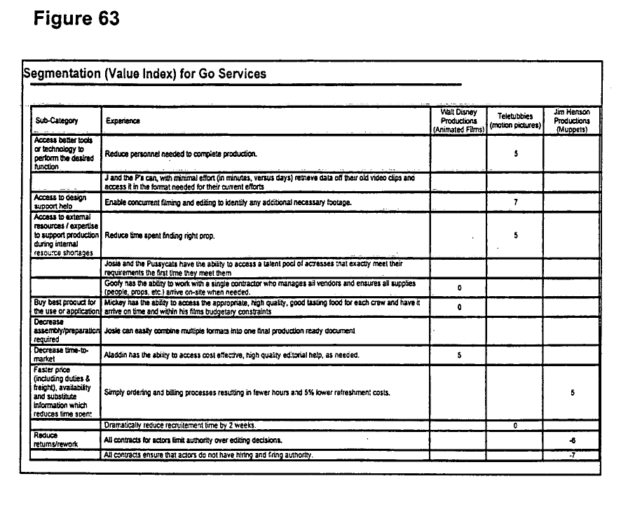

The database is queried for information relative to the segmentation report type, as described above which is stored in temporary pivot tables used to create a DHMTL table populated with the relative information using mathematical formulas within the stored procedures (described above) to aggregate information from value proposition and value delivery tables (i.e. segmentation-specific data is not maintained in separate tables, but is created ad-hoc based on the user selection of the segmentation report type). Screenshots reflecting the three types of segmentation reports can be seen in FIGS. 61-63. After the segmentation reports are generated, the team holds a meeting to review the findings (step 806) and draw conclusions.

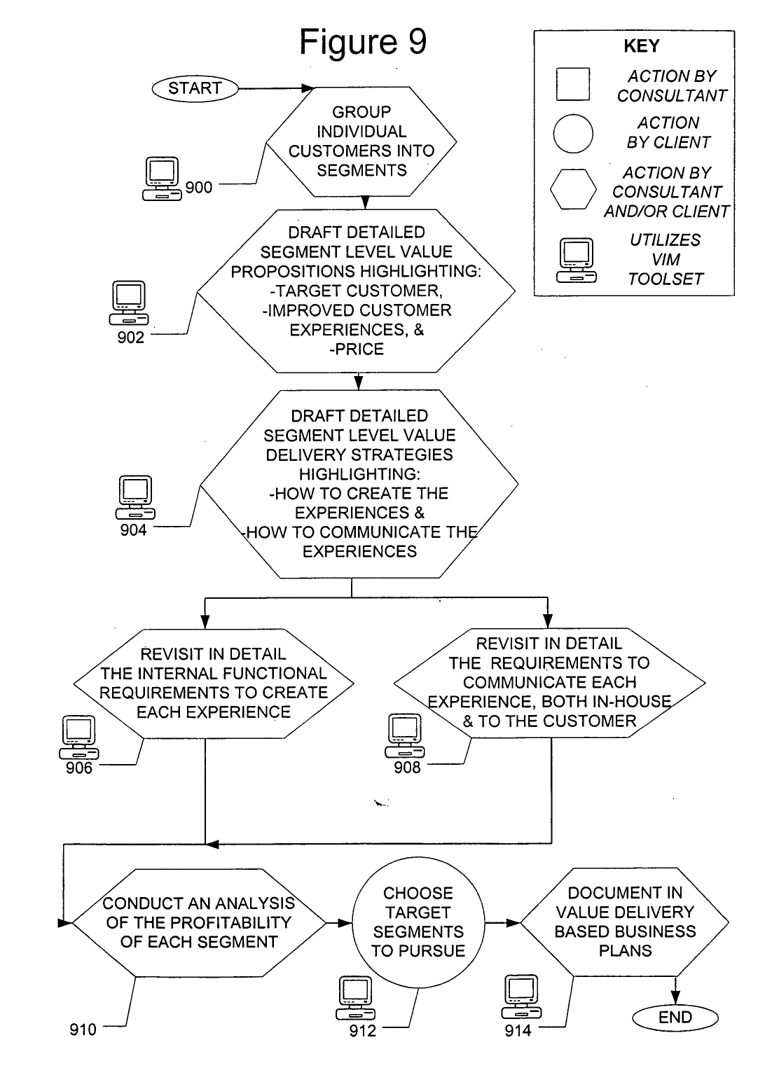

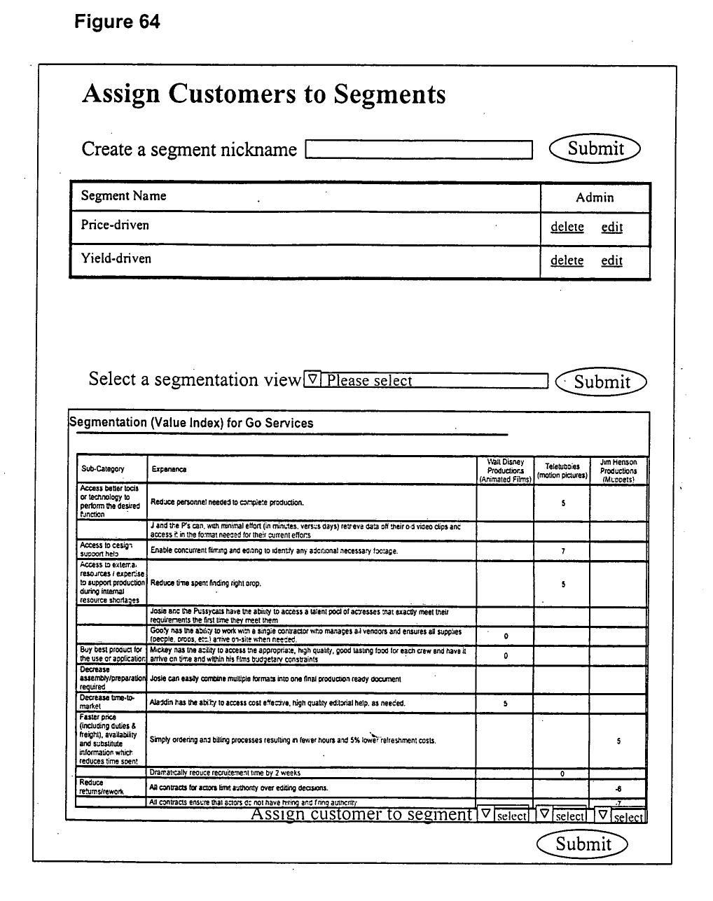

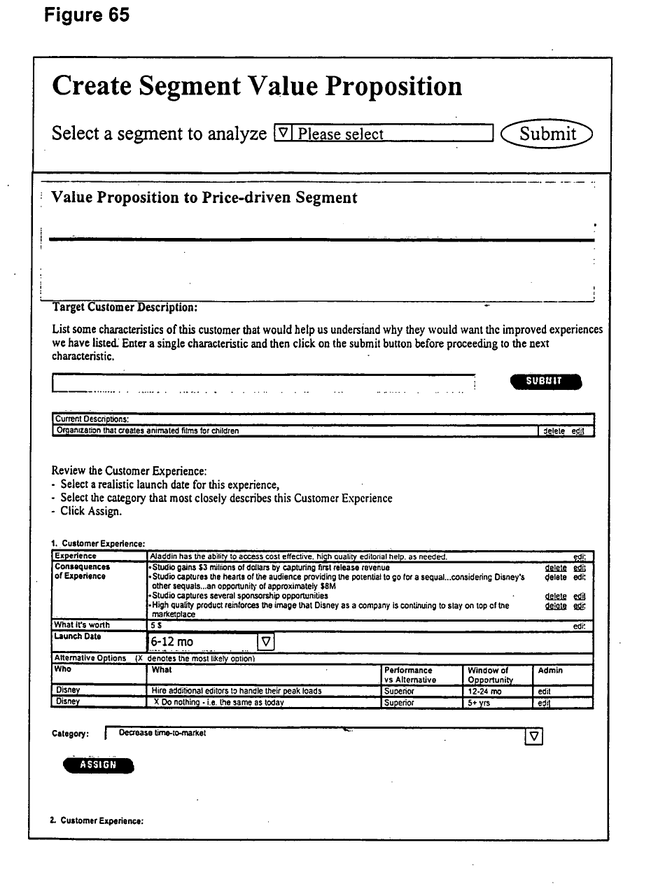

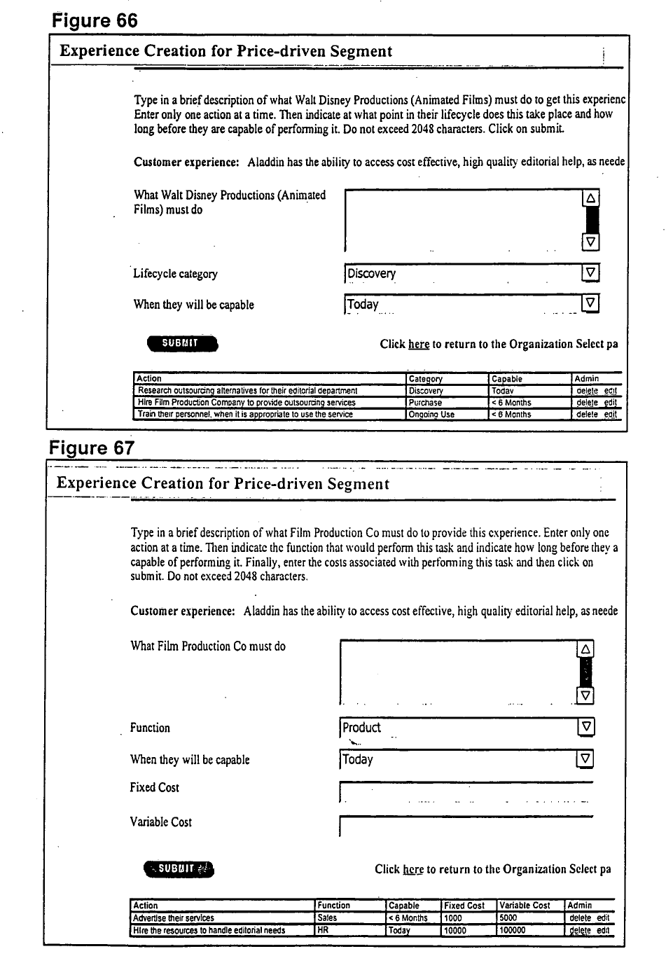

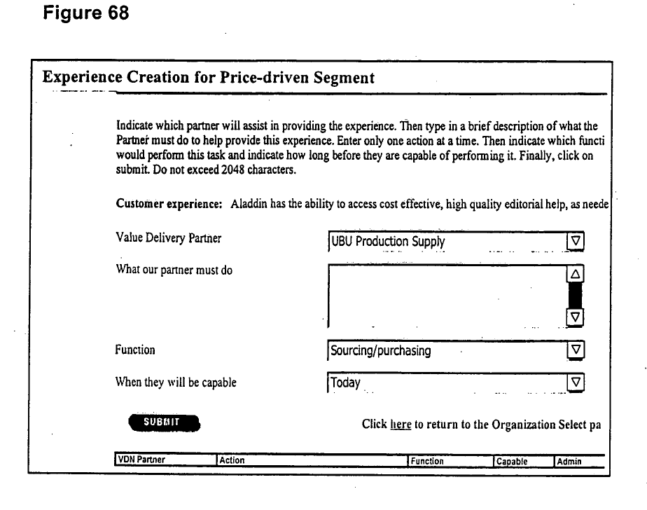

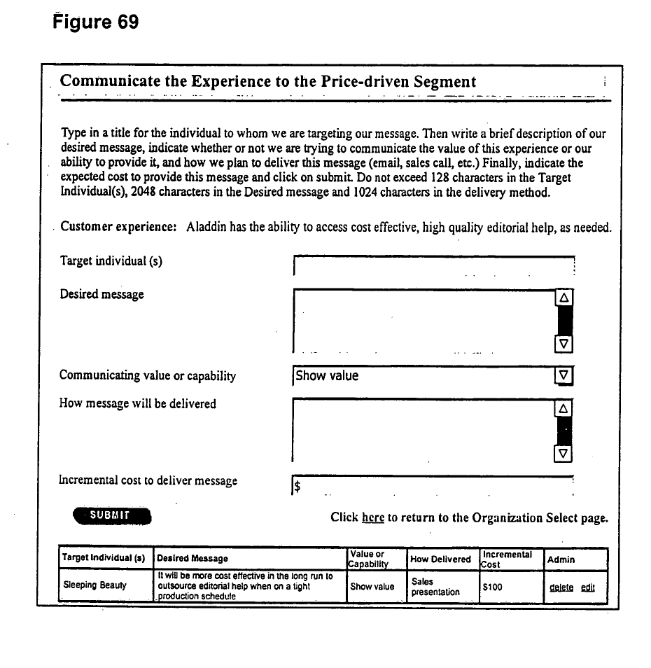

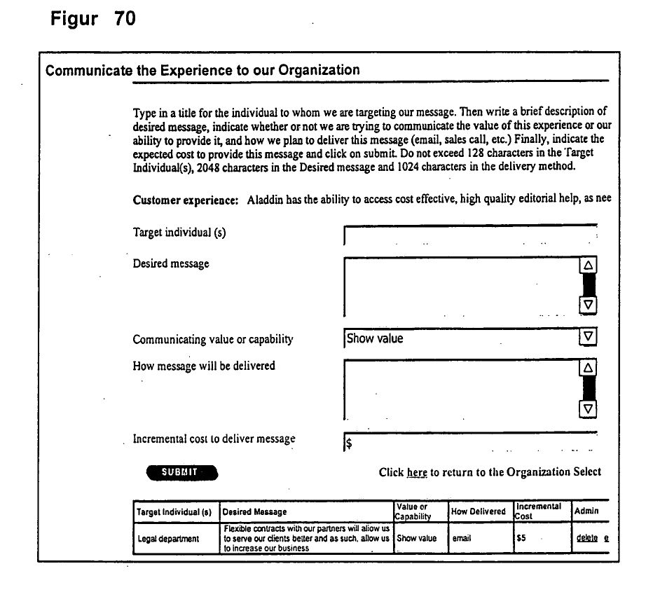

Once the team has reviewed the segmentation reports, the user then utilizes the system to group (step 900) the individual customers analyzed into segments (FIG. 9, steps 900-914). The user displays their preferred segmentation view (as described previously), and begins by creating a “nickname” for each segment. The user assigns customers to a segment via a pull-down menu containing the names of all customers previously entered into the invention. All the information from each assigned customer's value proposition “flows” into the segment level value proposition, enabling the user to visually search for and eliminate redundancies. The invention pulls aggregates data constrained at the company level or project level (dependent upon their access rights) into temporary pivot tables for editing (step 902) at a segment level. Once the segment level value proposition is created, all elements are fully editable using the same stored procedures as previously described in FIG. 7b. The user creates (step 904) segment level value delivery strategies using the same approach described previously in FIG. 7b, steps 732-744. Multiple users then view and edit those segment-level “value propositions” and value delivery systems” independent of physical proximity and a common meeting time (steps 906, 908). This automated synthesis of segment-specific customer strategies from individual customer interviews is missing from the prior art. It saves time and increases the comprehensiveness of the resulting strategies. Screenshots reflecting the creation of segment level value propositions and value delivery strategies can be seen in FIGS. 64-70.

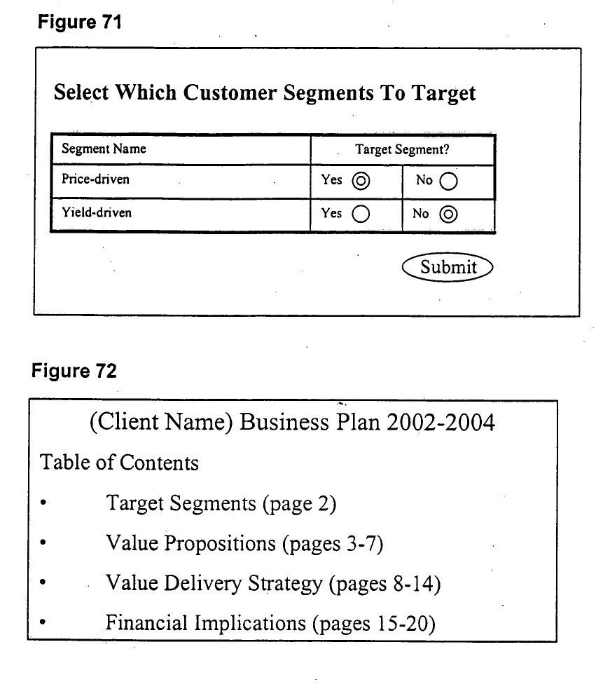

It is at this point where the team members review the cost and pricing assigned to each segment to determine the relative profitability of each segment (step 910). The invention provides a common framework for viewing (and as a result analyzing) multiple segments, allowing for an “apples to apples” comparison not easily accomplished through more traditional methodologies. The user then selects the target segments they wish to pursue (step 912) and the detailed value propositions and value delivery strategies utilized to build the target segmentation are referenced (linked) into a business plan report (step 914), using the same reporting mechanism and templates defined previously. Screenshots reflecting these actions can be seen in FIGS. 71-72. The present invention uses the customer data to directly create market-driven business plans, which cannot be accomplished with any combination of teaching in the prior art.

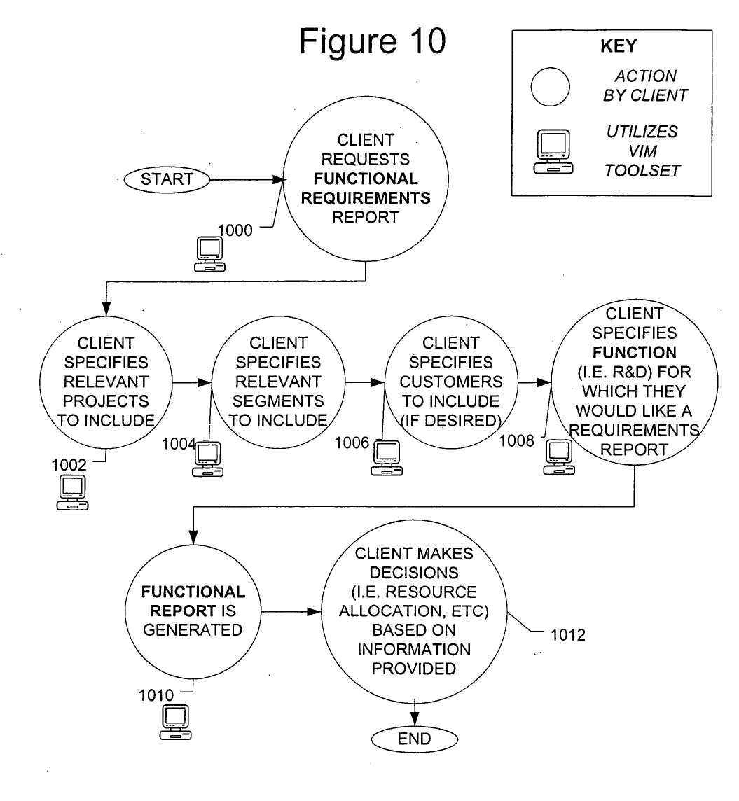

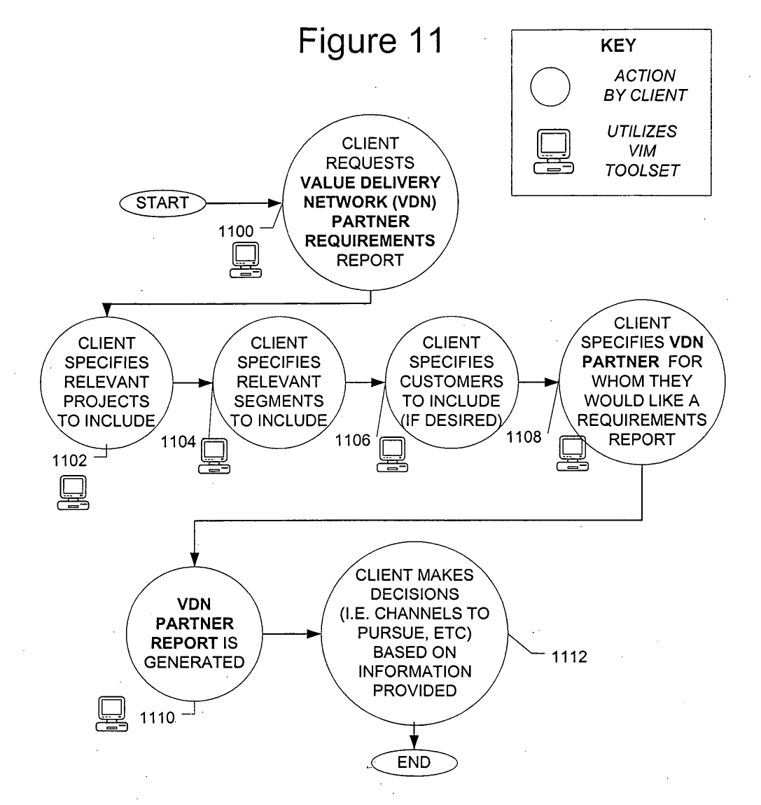

As seen in FIGS. 10-11, a user with sufficient access privileges (i.e. senior management or the site administrator) has the ability to look across multiple projects conducted by their organization and query the system to determine functional requirements for their organization (i.e., what does marketing need do to deliver on one or more of the value propositions created by this organization) (FIG. 10) and/or VDN partner requirements (i.e., what do the various partners specified by the team need do to deliver on one or more of the value propositions created by this organization) (FIG. 11). This data mining technique links a rigorous data gathering market research tool (that automatically creates segment-level value propositions and value delivery strategies) to a comprehensive cross-project and cross-divisional data-mining analysis tool (that automatically creates functional and/or business partner requirements for chosen segments).

Turning specifically to FIG. 10, to create a functional requirements report, the user specifies (step 1000) the report desired, indicates (steps 1002, 1004, 1006) the project(s), segment(s), and customer(s) they wish to include in the query, specifies (step 1008) the function for which they would like a report (e.g., R&D, Marketing, etc.), and a report is generated (step 1010). At this point, the user is presented with the key information required to make sound resource allocation decisions (step 1012).

This is accomplished via several stored procedures that validate the user's access, harvest the requisite data from the standard tables related to company projects, and then insert the data into data cube(s) for data mining and analysis. The data is harvested based on criteria selected by the user from drop-down listed that are populated with values that are dependent on the various projects completed within the company. The data is then analyzed based on values from drop-down lists selected by the user. These values are populated by the database relative to the projects stored for the specific company. Reporting is completed as previously described.

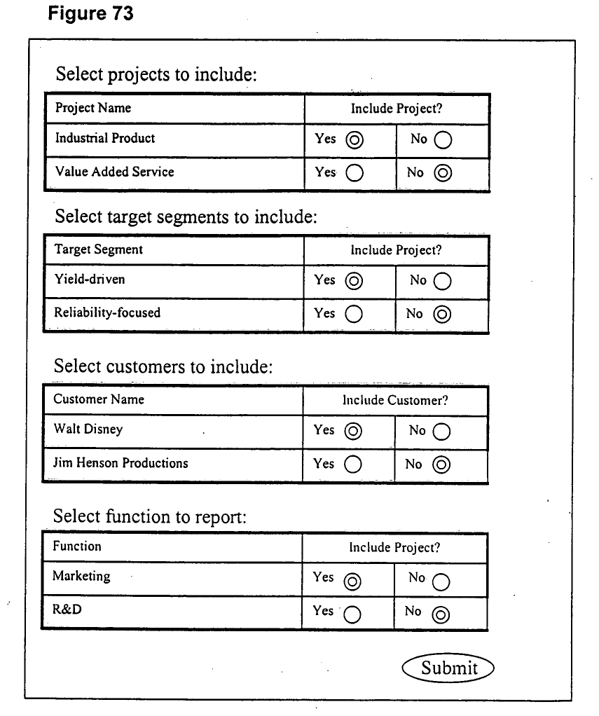

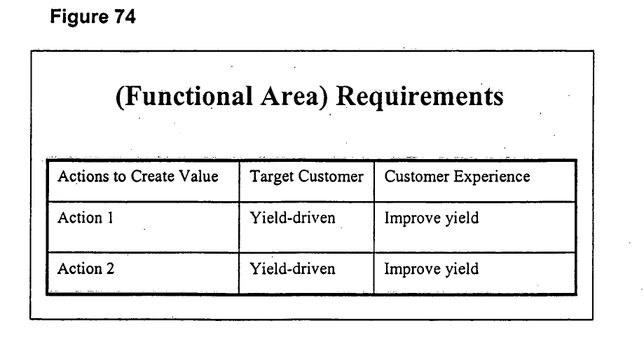

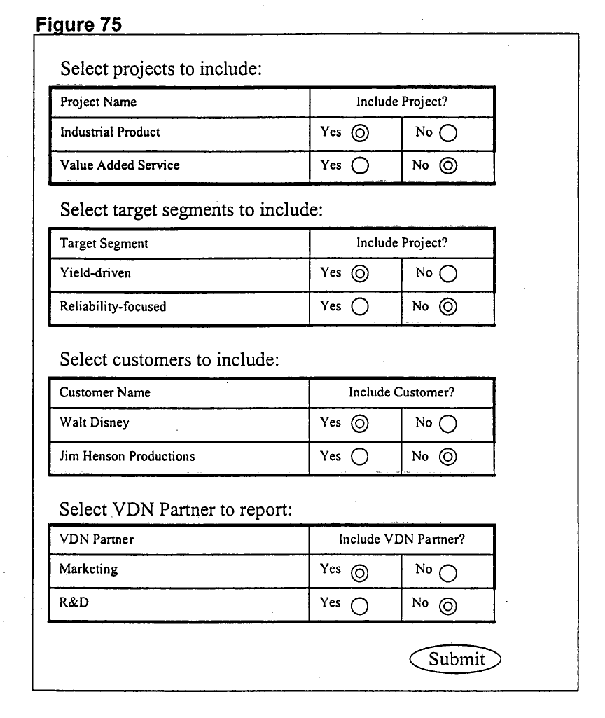

The process for generating a VDN partner requirement report (FIG. 11) is the same. The user requests (step 1100) a VDN partner requirement report, indicates (steps 1102, 1104, 1106) the project(s), segment(s) and customer(s) they wish to include in the query, specifies (step 1108) the VDN partner for whom they would like a report, and a report is generated (step 1110). The report provides the user with the key information required to make intelligent channel-partner choices (step 1112). Screenshots reflecting the user query options for the Functional and VDN partner requirement reports, as well as an abbreviated version of the reports generated can be seen in FIGS. 73-76.

In summary, the present invention leads the user “step-by-step” through the process of developing new insights on customer value, articulating that value in detailed value propositions, efficiently translating those value requirements into value delivery strategies, grouping customers into segments based on common or similar value propositions (with as few customer observations as possible), and then automatically creating functional and business partner requirements for the most profitable segments. This is all done in a manner that is faster, less time consuming, and more thorough than is possible with any tool or market research method currently available.

In view of the foregoing detailed description of preferred embodiments of the present invention, it readily will be understood by those persons skilled in the art that the present invention is susceptible to broad utility and application. While various aspects have been described in the context of screen shots, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

We claim:

1. A network-based, computerized method for enabling a client to identify a target customer and develop value delivery strategies for obtaining profitable business from the target customer, comprising the steps of:
defining a value delivery network of the client, the value delivery network including the target customer;
defining a team from the client to visit with the target customer;
during the visit with the target customer, documenting current events of relevance to the target customer and perfect events idealized by the target customer;
developing preferred events based on the current events and perfect events documented during the visit;
identifying improved experiences available to the target customer based on the preferred events;
quantifying a value of each improved experiences to the target customer;
developing a value proposition for the target customer based on the improved experiences identified; and
developing a value delivery strategy for implementing the value proposition.

2. The method of claim 1 wherein the step of documenting current events further comprises documenting previous experiences between the client and the target customer, documenting previous experience between the target customer and competitors of the client, and wherein the step of developing the value proposition includes assigning a relative performance value and a relative importance value to each improved experience identified.

3. The method of claim 1 wherein the value proposition includes a time horizon, required target customer experiences, and a price that will be charged by the client for each respective improved experience.

4. The method of claim 1 wherein interaction between the team and the target customer is defined by a work plan of a project and wherein each member of the team is permitted to modify the work plan on an on-going basis.

5. The method of claim 1 further comprising the step of providing the team with surveys for completion prior to the visit to the target customer.

6. The method of claim 1 further comprising the step of identifying the target customer from a list of current and potential customers.

7. The method of claim 1 further comprising the step of identifying improvement opportunities for the target client based on the documented current events and perfect events.

8. The method of claim 1 wherein each improved experience is assigned a worth to the customer and consequences of the improved experience are identified.

9. The method of claim 8 wherein, for each improved experience, a best alternative most likely to provide the improved experience or a similar experience to the target customer is identified, the best alternative being a competitor of the client.

10. The method of claim 1 wherein the step of developing the value delivery strategy comprises defining how each improved experience will be created for the target customer and defining how each improved experience will be communicated to the target customer and within the client.

11. The method of claim 10 wherein the step of defining how each improved experience will be created comprises identifying required actions by the target customer, the client, and value delivery partners.

12. The method of claim 10 wherein the step of defining how each improved experience will be communicated comprises identifying content and mode of delivery of the communication with the target customer and the client.

13. The method of claim 10 wherein members of the team are able to modify the value delivery strategy remotely and independently of other team members.

14. The method of claim 1 further comprising identifying required actions of the client, partner organizations, and the target customer to experience the value proposition over a chosen time horizon.

15. The method of claim 14 wherein the required actions are assigned to specific functional areas within the client or to at least one of the partner organizations and wherein the assigned required actions are stored in a database of the network.

16. The method of claim 14 wherein the required actions are assigned estimates of cost and time until implementation and wherein the required actions are stored in a database of the network.

17. A network-based, computerized method for enabling a client to identify customers and develop value delivery strategies for obtaining profitable business from the customers, comprising the steps of:
defining a respective team from the client to visit with each of a plurality of customers;
visiting each of the plurality of customers;
during each respective visit, documenting current events of relevance to each respective customer and perfect events idealized by each respective customer;
developing preferred events for each respective customer based on the current events and perfect events documented during each respective visit;
identifying improved experiences available to each respective customer based on the preferred events;
quantifying a value of each improved experiences to the customer;
developing a respective value proposition for each respective customer based on the improved experiences identified;
developing a respective value delivery strategy for implementing each respective value proposition; and
grouping the plurality of customers into common segments based on similarity of respective value propositions or value delivery strategies.

18. The method of claim 17 further comprising the step of creating segment and line of business level requirements for functional areas within the client and for business partner organizations that help serve the customers.

19. The method of claim 18 wherein a single user or multiple users of the client individually or simultaneously query a database of the network to create subsets of data that relate only to one or more of the following common elements: client, client line of business, client project, client functional area, partner organization, customer, customer segment, customer experience, and price charged to the customer.

20. The method of claim 17 wherein value propositions and value delivery strategies are developed for at least one of the common segments.
